(19) United States
(12) Patent Application Publication
(10) Pub. No.: US 2009/0327006 A1
(43) Pub. Date: Dec. 31, 2009

(54) SYSTEM, METHOD AND COMPUTER PROGRAM PRODUCT FOR AUTHENTICATION, FRAUD PREVENTION, COMPLIANCE MONITORING, AND JOB REPORTING PROGRAMS AND SOLUTIONS FOR SERVICE PROVIDERS

(75) Inventors: Mark D. HANSAN, Bethesda, MD (US); Edward C. O'ROURKE, Darnestown, MD (US)

Correspondence Address: DOSTER GREENE, LLC, #215, 2 WISCONSIN CIRCLE SUITE 700, CHEVY CHASE, MD, 20815, US

(73) Assignee: CERTICLEAR, LLC, Bethesda, MD (US)

(21) Appl. No.: 12/493,004

(22) Filed: Jun. 26, 2009

Related U.S. Application Data
(60) Provisional application No. 61/075,780, filed on Jun. 26, 2008.

(51) Int. Cl. G06Q 10/00; G06Q 40/00

(52) U.S. Cl. 705/7; 705/31; 705/30

(57) ABSTRACT

A system and method of using a computer to prevent fraud and abuse and to promote reporting transparency, according to various exemplary embodiments, can include receiving data of an entity and individuals; accessing data about the entity and individuals in one or more remote computers to prevent fraud and abuse from being committed by the entity or the individuals; determining whether the data of the entity and individuals satisfies a plurality of criteria and issuing a certification identification number if the data of the entity and individuals satisfies the plurality of criteria; determining whether the data of the entity and individuals is in compliance with at least one government regulation; and defining a plurality of customized criteria and determining whether the data of the entity and individuals satisfies the plurality of customized criteria.

### REFERENCE TO RELATED APPLICATION

This application is a continuation-in-part of provisional application Ser. No. 61/075,780, filed Jun. 26, 2008, which is incorporated by reference herein.

### BACKGROUND OF THE INVENTION

1. Field of Invention

The present invention relates to an authentication, fraud prevention, compliance monitoring, and job reporting method, apparatus, and systems for all types of service providers. More particularly, the present invention relates to an authentication and verification system to assist consumers and businesses in choosing a service provider. The present invention further relates to a fraud prevention system and method that mitigates risk by providing a front-end authentication and verification to prevent fraud and abuse. The present invention provides a system and method that improve the transparency of contracts by generating compliance reports at ail contract levels to strengthen downward monitoring and accountability to the lowest contract level. In addition, the present invention relates to an automated job growth and retention reporting system and method for facilitating a compliance program in accordance with the rules and regulations of a government program.

2. Description of the Related Art

With the development of recent technology, especially the Internet, consumers and businesses make decisions to purchase goods and services from service providers on a regular basis. Most decisions regarding whether to conduct a transaction with a specific service provider can depend upon various factors. For instance, a consumer may not hire a professional service provider such as an attorney, doctor or financial planner without considering several criteria as education, years of experience, area of expertise, and prior professional complaints or grievances. Similarly, a government agency often will not do business with a government contractor without assessing many criteria such as financial stability, technical capability, past performance, and quality. In many situations, consumers and businesses have to make decisions on the basis of incomplete, partial or inaccurate information. From the customer's perspective, the likelihood of successfully receiving the requested goods and the services generally rely on the accuracy of the information provided by the service provider. Oftentimes, problems arise where the information provided by the service provider is not accurate or where the service providers misrepresent their qualifications, training, experience or background.

Misrepresentations by service providers of their backgrounds can put consumers and businesses at risk of hiring an entity or individual lacking in training or experience. Directly or indirectly, such misrepresentations can expose the consumer or businesses to unethical business practices and scam operators, which can lead to legal liabilities for the consumer or business and, in some unfortunate situations, can lead to physical harm to the consumer. One industry that is known for its fraud and abuse scandals is government contracts. The federal government of the United States is the largest consumer purchasing all types of goods and services. Government spending has always drawn fraudsters, and the current stimulus spending of the American Recovery and Reinvestment Act of 2009 will add to the potential for corruption. Often, a single procurement contract issued by a government agency can be awarded such that multiple recipients are hired to perform or provide services at different levels of the contract. However, each stage of the procurement contract offers opportunities for different players to commit fraud or abuse. It has been reported that fraud and abuse corruption raises procurement contract costs by at least 10 percent. Accordingly, there is a need to verify the accuracy of information provided by service providers. Likewise, there is a need to expose inaccurate information provided by service providers. Further, there is a need to facilitate the decision making process of a consumer, business or government agency when selecting a service provider.

Furthermore, as consumers open their homes to service providers and business owners establish partnerships with individuals and other businesses that render services, it is important for reputable entities, such as business owners, independent contractors, service providers and community leaders to differentiate themselves from scam operators and unethical business practices. In addition to providing reputable entities with a method of differentiating themselves, there also is a need for an authentication and verification system that can help assist a consumer or business to choose a reputable service provider regardless of the type of services rendered. In addition, as companies form business relationships, it is crucial for companies that use agents, joint venture partners and the like to investigate these intermediaries that they may use to facilitate a business endeavor. Moreover, intermediaries are a common conduit for those who wish to make improper payments and commit fraud and abuse. However, passing responsibility to intermediaries does not transfer liability for the actions of agents and can leave companies with considerable legal and financial exposure. Companies seeking to identify in advance their potential exposure by forming a partnership with an intermediary should conduct a thorough investigation of the intermediary to look out for traits of corruptions. During such an investigation, if any issues of concern are discovered, it is imperative for the company to scrutinize the intermediary further. Failure to do so may result in serious repercussions for the company on numerous levels; legal, financial, business and reputational. Thus, there is a need to provide a system and method that can be customized to conduct a further in depth investigation of an intermediary or any service provider based upon the area of concern.

Such an authentication and verification system is particularly needed in the field of elder care service providers, because senior citizens are one of the most vulnerable groups that are frequently targeted by scam operators and unethical businesses. However, the current standards which govern professionals and service providers—including their employees and volunteers—that work for or, on behalf of seniors, are fractured, inconsistent and unreliable. As a result, the lack of clear, consistent standards and regulations puts seniors in our society in a vulnerable position for fraud and abuse. The need for communicating a higher standard in the marketplace has never been greater given the rapidly expanding senior population. As the institutionalized care model is replaced by seniors who opt to “age-in-place” throughout the remaining years of their lives, the demographic shift has magnified the need for services to be provided within the home.

Consider that the overall senior marketplace includes 40 million Americans over the age of 60 with annual spending power of more than $1 trillion dollars. The senior population (aged 65 or older) is increasing more rapidly than any other segment and is projected to grow to 70 million by 2030. The vast majority of these seniors are choosing to “age-in-place” instead of moving away from their homes and communities. Seniors want to remain independent for as long as possible; however, as their need for assistance from others increases, traditionally, seniors have relied upon family members as the primary source of care giving. Studies indicate 80 percent of care giving is provided by family members; but within one generation, we have experienced a decreasing number of children per family and a separation of families due to almost two-thirds of adult children not living in the same communities as their parents.

The void of nearby family members in many cases is beginning to be filled by a significant increase in new companies and a rapidly growing service based and professional workforce. The demand for professionals and service providers of all types is tremendous. Because senior citizens as a group are wealthier than other population segments or have access to the government funded Medicaid program, the new workforce has attracted people who do not necessarily have the best of intentions. Government funded programs will continue to attract new service providers which further overwhelms understaffed state agencies already attempting to stem Medicaid fraud, waste, and abuse. The General Accounting Office estimates waste, fraud, and abuse to be 10% of all Medicaid spending. There has been a recent call for transparency by government officials and policy makers to ensure taxpayer funds are used in a manner that provides clarity, transparency, and accountability. Furthermore, there is a growing and urgent need to assist and protect vulnerable senior citizens from elder abuse. According to a 2004 study published in the journal Lancet “estimates of the frequency of elder abuse range from 2 percent to 10 percent based on various sampling, survey methods, and case definitions.” An in-depth analysis performed on behalf of the National Center for Elder Abuse reported in 2006 that caregiver neglect represented 24 percent and financial exploitation represented 21 percent of all cases.

This has created the need to help consumers, businesses, and government agencies identify legitimate “fair” businesses from those companies having a criminal history or track record of fraud, exploitation and financial scams. Consumer laws and regulations in each state are not thorough enough to protect vulnerable populations and ethics are very hard to regulate. There is a need for standards to supplement the lack of clear, consistent standards and regulations of businesses to safe-guard the interests of consumers, businesses, and government agencies.

There is also a need for initial background screening of the service providers followed by annual and/or random monitoring and background checks. Traditionally, background check standards are most commonly identified as a component of the human resource employee hiring process; where employers are seeking the best possible employees. In the business community, background checks can be performed to search for a range of issues such as credit risk, open litigation and judgments, verification of business license, business references, etc. Traditionally, employers have led the effort to check employees as part of the hiring process checking areas like criminal history, driving record, drug testing, professional licenses, employment history and references. However, rarely does the industry check the status of an individual on a recurring annual basis. In the healthcare industry, healthcare background checks are regulated by states and as a requirement for participation in Medicare programs. However, contrast the healthcare industry with the fact that most other industries check backgrounds initially but not on-going. Also, they tend to focus more specifically on the areas that are industry specific. For instance, transportation companies typically focus heavily on driving record and drug testing but not necessarily conduct a lengthy federal search (7 to 10 years) for a criminal background. Most businesses are required by law to have proper business licensing: however few businesses check their current operating status. This lack of checks and balances allows companies to deploy workers, for example, to a senior's home without sufficient knowledge of the worker's history or intent. In addition, today's volunteers are not held to any specific regulated background checks. The National Association of Professional Background Screeners has recognized this fact, “Companies and organizations are often so happy to have volunteers that they assume a volunteer's spirit of public service and dedication to community denote someone who couldn't possibly have a blemish in their background.”

Currently, senior service background check standards are regulated state by state, according to industry by industry standards in the area of the background search. The laws are often confusing and therefore, assurance that they are in place and current is unreliable. In any event, they provide insufficient assurances to seniors.

Therefore, what is needed is an authentication and verification system that can confirm the reputation and integrity of a service provider to assist consumers in choosing such a service provider. What is also needed is such a verification and authentication system that enables a reputable entity to enroll in the application process to become pre-qualified as a trusted and authenticated service provider.

In situations where a service provider offers services in a regulated industry, in addition to the need to initially authenticate and verify the service provider, there is oftentimes a need to continue to monitor the sen ice provider to determine whether the services rendered comply with applicable rules and regulations. Furthermore, there is a need to provide a system and method that is capable of being tailored and customized by a user to authenticate and verify a service provider based upon one or more pre-defined criteria. There is a need to customize the authentication and verification process so that a user can identify specific data points and

### SUMMARY OF THE INVENTION

The present invention may satisfy one or more of the above-mentioned desirable features. Other features and/or aspects may become apparent from the description which follows. Various embodiments of the authentication and verification system and method described herein enable the confirmation of the reputation and integrity of a sercice provider to assist consumers in selecting a service provider. In various embodiments, the authentication and verification system and method enable a reputable entity to enroll in the application process to become pre-qualified as a trusted and authenticated service provider. Various embodiments of the system and method can be used to monitor a service provider that operates in a regulated industry to facilitate compliance monitoring, and periodic collection, storage and reporting of data to the required government agency to promote spending transparency. Various embodiments of the system and method enable a user to tailor and customize an authentication and verification of a service provider based upon one or more pre-defined criteria.

With the population growing to 70 million seniors by 2030, this country faces an urgent need for new solutions for seniors and their family members. One embodiment of the present invention provides technology that is leading the effort to raise the standards and make a difference in the lives of senior citizens and their family members. The authentication and verification program and additional products and services of the present invention can significantly enhance existing service providers. More importantly, these providers form the basis for the nation's truly “authenticated” and trusted network of service companies, organizations and individuals dedicated to helping millions of seniors and their family members.

A method of using a computer, according to various embodiments, can include receiving data of a plurality of businesses; accessing data about the plurality of businesses in one or more remote computers; for each business, determining whether the data satisfies a plurality of business criteria; issuing a certification identification number for each business for which the data of the business satisfies the plurality of business criteria; not issuing a certification identification number for each business for which the data of the business does not satisfy the plurality of business criteria; receiving data of a plurality of individuals; accessing data about the plurality of individuals in one or more remote computers; for each individual, determining whether the data satisfies a plurality of individual criteria; issuing a certification identification number for each individual for which the data of the individual satisfies the plurality of individual criteria; not issuing a certification identification number for each individual or which the data of the individual does not satisfy the plurality of individual criteria; storing in a database identifying information for each individual and business having issued a certification identification number; and allowing consumers to access the database, via the Internet or by telephone, to verify that a person or company has been issued a certification identification.

A method of using a computer, according to various embodiments, can include receiving data of a plurality of businesses; accessing data about the plurality of businesses in one or more remote computers; selecting one or more pre-selected businesses from the plurality of businesses; for each pre-selected business, defining a plurality of customized business criteria; for each pre-selected business, determining whether the data satisfies the plurality of customized business criteria; issuing a certification identification number for each pre-selected business for which the data of the business satisfies the plurality of customized business criteria: not issuing a certification identification number for each pre-selected business for which the data of the pre-selected business does not satisfy the plurality of customized business criteria; receiving data of a plurality of individuals; accessing data about the plurality of individuals in one or more remote computers; selecting one or more pre-selected individuals from the plurality of individuals; for each pre-selected individual, defining a plurality of customized individual criteria; for each pre-selected individual, determining whether the data satisfies the plurality of customized individual criteria; issuing a certification identification number for each pre-selected individual for which the data of the pre-selected individual satisfies the plurality of customized individual criteria; not issuing a certification identification number for each pre-selected individual or which the data of the pre-selected individual does not satisfy the plurality of customized individual criteria; storing in a database identifying information for each pre-selected individual and pre-selected business having issued a certification identification number; and allowing users to access the database, via the Internet or by telephone, to verify that a person or company has been issued a certification identification.

A method for collecting and reporting data for facilitating an American Recovery and Reinvestment Act of 2009 (Recovery Act) compliance process using a computer, according to various embodiments, can include receiving data of a plurality of entities; accessing data about the plurality of entities in one or more remote computers; receiving data of a business relationship between each contractual related entity of the plurality of entities, wherein the contractual related entities are associated based upon a contract; receiving contract data based upon the contract; tracking data of a number of jobs created by the contractual related entities based upon the contract; tracking data of a number of jobs retained by the contractual related entities based upon the contract; storing in a database the data of the number of jobs created and the data of the number of jobs retained based upon the contract; calculating data of a jobs created full-time equivalent based upon the data of the number of jobs created and calculating a jobs retained full-time equivalent based upon the number of jobs retained; storing in the database the data of the jobs created full-time equivalent, the data of the jobs retained full-time equivalent, and the contract data; determining whether the data of the jobs created full-time equivalent, the data of the jobs retained full-time equivalent, and the contract data satisfy requirements of the Recovery Act; and periodically reporting, based on a pre-determined time period, the data of the jobs created full-time equivalent, the data of the jobs retained full-time equivalent, and the contract data to a government agency.

A computer system for implementing an authentication, compliance monitoring, and job reporting program, according to various embodiments, can include a processor and a memory, coupled to the processor, to receive and store data associated with an entity. The memory can further include code that is executable by the processor and the code can comprise an authentication and verification application, a job counting application, and a customized fraud prevention application. The authentication and verification application can be configured to determine whether the data of the entity satisfies a plurality of criteria and to issue a certification identification number if the data of the entity satisfies the plurality of criteria. The job counting application can be configured to track data of a number of jobs created by the entity based upon a contract, track data of a number of jobs retained by the entity based upon the contract, and configured to determine whether the data of the number of jobs created, the data of the number of jobs retained, and contract data based upon the contract satisfy requirements of an American Recovery and Reinvestment Act of 2009 compliance program. The customized fraud prevention application can be configured to define a plurality of customized criteria and determine whether the data of the entity satisfies the plurality of customized criteria,

A method of using a computer to detect fraud and abuse and to promote spending transparency, according to various exemplary embodiments, can include receiving data of an entity; accessing data about the entity in one or more remote computers to detect occurrences of fraud and abuse committed by the entity; determining whether the data of the entity satisfies a plurality of criteria and issuing a certification identification number if the data of the entity satisfies the plurality of criteria; determining whether the data of the entity is in compliance with at least one government regulation; and defining a plurality of customized criteria and determining whether the data of the entity satisfies the plurality of customized criteria.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

FIG. 1 is a diagram of the authentication and verification system according to an embodiment of the service provider and individual (employee) process of the present invention;

FIG. 2 is a diagram of the authentication and verification system according to an embodiment of the consumer process of the present invention;

FIG. 3 is a workflow diagram of the application process for certifying a business and individuals as an authenticated service provider;

FIG. 4 is a workflow diagram of the method for capturing and processing insurance and bond documents from service provider applicants;

FIG. 5 is a workflow diagram of the method for verifying an individual as an authenticated service provider;

FIGS. 6A-6D is a table showing an example of the authentication data gathered by the program regarding an organization during the application process;

FIGS. 7A-7C is a table showing another example of the authentication data gathered by the program regarding an organization during the application process;

FIGS. 8A-8B is a table showing an example of standards that can be used for performing a business background check and for certifying the business;

FIGS. 9A-9B is a table showing an example of standards that can be used for performing a background check on an individual and for certifying the individual;

FIG. 10 illustrates an embodiment of the job counting platform according to the present invention;

FIG. 11 illustrates an embodiment of the job counting platform according to the present invention;

FIG. 12 illustrates an embodiment of the dashboard feature of the job counting platform according to the present invention;

FIGS. 13A-13B depict real-time reports generated by the job counting platform according to the present invention;

FIGS, 14A-14B is a workflow diagram of the job counting process according to the present invention; and

FIGS. 15A-15B illustrate an embodiment of the fraud prevention platform according to the present inventions.

### DETAILED DESCRIPTION

### Overview

The system and method provides a platform that offers a variety of features and services that can be expanded and scaled back based on the application of the present invention. Some of the main features and services of the system and method include: verifying an entity; conducting background checks on an individual, such as an owner or employee, who is associated with an entity; credentialing an entity or individual, using tools of transparency to report results and to generate data compliance reports; monitoring and tracking the number of jobs created and retained under a specific contract or funding award; and periodically collecting, storing and reporting data in compliance with a regulatory program.

Various embodiments of the present invention describes an authentication, fraud prevention, compliance monitoring, and job reporting method, apparatus, and systems for all types of service providers. Various embodiments of the present invention relates to an authentication and verification system to assist customers and businesses in choosing a service provider. In some embodiments, the present invention further relates to a fraud prevention system and method that mitigates risk by providing a front-end authentication and verification to prevent subsequent fraud and abuse. In various embodiments, the present invention relates to a system and method for automated determination of compliance with standards and regulations and provides an automated job growth and retention reporting system and method.

The system may be implemented via a computer system that includes one or more computers and including at least one server connected to the Internet. Servers described herein may include one or more computer systems that each include a processor, memory, user input and user output mechanisms, a network interface, and executable program code (software) stored in memory that executes to control the operation of the server. Various commercially available computer systems and operating systems software may be used to implement the hardware and the conventional software. The components of each server may be co-located or distributed. In addition, all or portions of the same software and/or hardware may be used to implement two or more of the functional servers shown or discussed. Thus, in some embodiments the components may be considered functional components that employ the same hardware and some of the same program code. Other embodiments may include different functional components. In some alternate embodiments, all of the functional components may be performed by the web server that serves the client (the browser) web page.

In the following description, for purposes of explanation and not limitation, specific details are set forth, such as particular networks, communication systems, computers, terminals, devices, components, techniques, advertisements, ad units, and unit types, servers, communication paths, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, advertisements, ad units, ad unit types, servers, communication paths, data and network protocols, software products and systems, operating systems, development interfaces, and hardware are omitted so as not to obscure the description.

Authentication and Verification System

Various embodiments of the present invention enable consumers and businesses wishing to purchase goods and services from service providers to ensure the integrity of the service providers and their employees. Various embodiments of the present invention verify the accuracy of information provided by service providers to assist consumers and businesses with their selection of a service provider. Various embodiments of the present invention provide an automated standards verification process that conducts an evaluation on one or more service providers. The request to conduct the evaluation can be submitted by the service provider or initiated by a third party. For example, the service provider may submit a request to undergo the evaluation process in order to be verified and enrolled as an authenticated provider. Another example is that a third party, such as a government agency, may submit a request for an evaluation of a prime contractor before awarding a contract to the prime contractor.

Various embodiments of the present invention include an authentication program for authenticating and verifying services provided by either an individual or an entity. Some embodiments of the present invention can be configured to subject an individual or business service provider to an authentication process that evaluates and rates the service provider in comparison to a rigorous set of criteria. In cases where the service provider is an entity, the authentication program of the present invention can authenticate and verify the entity down to an individual employee level to mitigate risk and prevent fraud and abuse.

Operation of the system and method can be coordinated by an authentication platform, which functions as the main platform to provide communications through a network with a user to receive an authentication request, menu selections, and the like, and to provide information in response. In addition, the authentication platform can implement an authentication process to verify and authenticate the service provider. During operation, the authentication platform can be configured to initially perform a user registration and/or login procedure. The authentication platform can include a profile database for storing registration, application and login information.

The system and method can be configured to accept the registration and application information via an input device using various formats, including for example: (1) free text, (2) multiple-choice and/or (3) audio/visual. An example of free text is a contractor's company brochure or a job applicant's resume. As commonly known, a multiple choice form is a questionnaire or checklist in which acceptable answers are limited to those provided in or with the questionnaire or checklist. An example of audio/visual is a photographic identification such as a driver's license or a passport or copies of insurance documents.

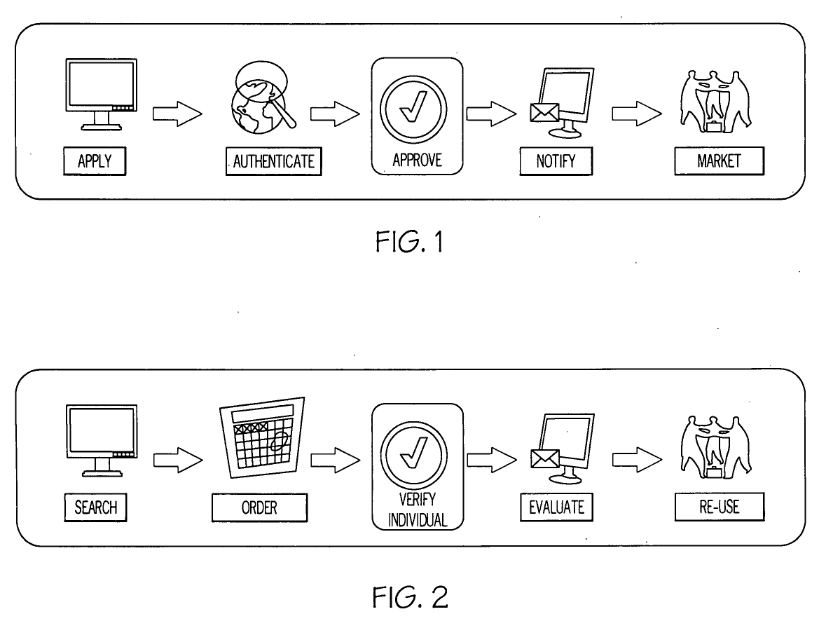

Using one or more of the input devices, a service provider can fill out an application which may include, for example, an on-line application for entering the information to be verified. FIG. 1 illustrates a user interface for collecting registration and application information from a service provider consistent with the present invention. The application can provide text boxes and/or drop-down lists for the service provider to enter information. For individual service providers, the application can include personal information such as name, address, telephone number, fax number, and e-mail address. The system can be configured such that an applicant requesting authentication and approval must pay for the authentication process. If the service provider must pay a fee in order to request the system to perform the evaluation process, the application can additionally include payment information such as a credit card number and type, and an expiration date and billing address associated with the credit card.

The embodiments described herein preferably automate one or more, but preferably most or ail, of the described functions. However, some aspects of the authentication process may be performed by telephone, use of the Internet, mail, facsimile or employing other communication techniques.

After receiving the service provider's information, using the authentication platform, the system can create and store a data record that pertains to the service provider's profile data within a profile database. The data record may be assigned a unique identifier.

The system then formulates and sends a query to one or more databases based upon the information provided on the application regarding the service provider. The databases may be located on either an internal network or another entity's network wherein the query and query results are transmitted via an Internet connection. For example, the system may forward a query to another entity's database such as a state regulatory board to verify the service provider's professional license status. One or more databases may respond to the query by providing one of several types of responses. To verify the service provider, the database may respond by providing any and all information that matches the records associated with the information provided on the application. The query results can be returned and stored as data metrics such that each query result is associated with an attribute of the service provider. Applying a set of rules, the authentication platform can also define the information provided on the service provider's application as attributes based on the set of predefined criteria. Various embodiments of the present invention can gather information regarding attributes of the service provider based upon the set of criteria for the purpose of scoring and rating the service provider. Examples of some of the major categories of these attributes can include a background check; compliance with federal, state, or local laws, industry licenses; general or professional liability insurance; crime bond status, and the like.

The authentication program can calculate an evaluation value based on the attributes in comparison to the predefined set of criteria to determine whether the authentication is successful if it exceeds a predetermined evaluation value. The authentication program can then report the results of the evaluation. The report can be a simple “PASS” or “FAIL” response or a more detailed report. For example, when a “FAIL” result is reported, the system can be configured to automatically generate a report detailing information why the service provider failed the authentication and verification process. A service provider that receives a “PASS” rating can also request a report detailing the service provider's strengths and areas of needed improvement. In a third party request, the third party can customize the evaluation process according to relevant attributes or set of criteria as predefined by the third party.

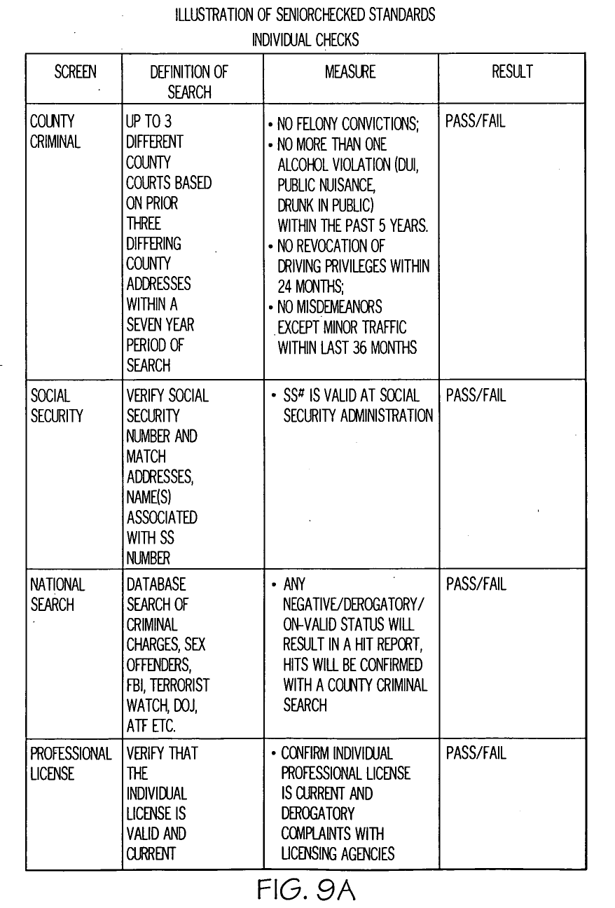

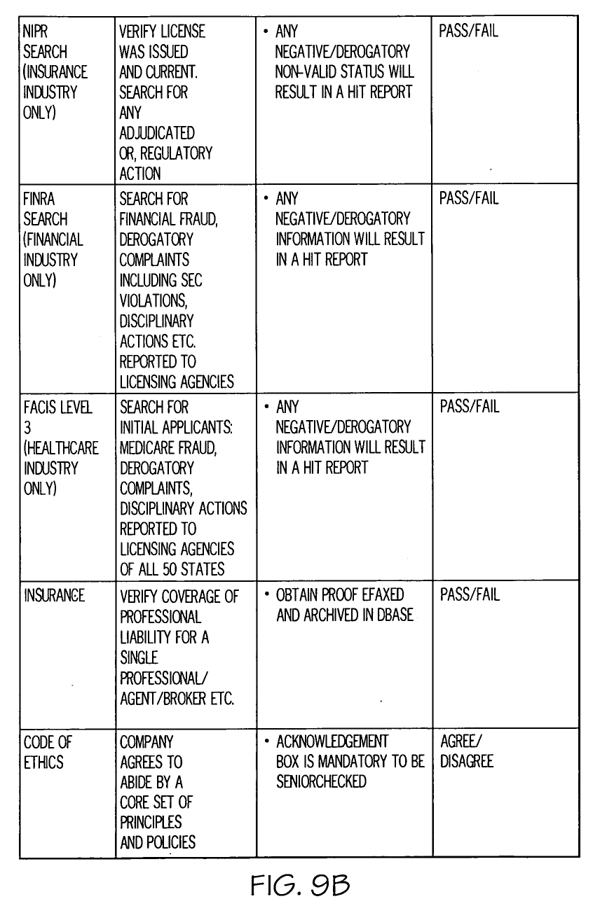

In addition to conducting a traditional background check on the service providers, according to the present invention, the verification process can be configured to be industry specific. Namely, during the application process, the verifiable information requested to be provided by a service provider in one industry may differ from a service provider who operates in another industry. For example, a government contractor may be requested to provide information to substantiate its technical, past performance, and management credentials to determine whether the contractor has the capacity and qualifications to successfully complete a specific contract. On the other hand, a college professor may be requested to submit verifiable information regarding teaching and research experience, publications, presentations, awards, honors and affiliations. Accordingly, in such embodiments, the system and method can be configured to automatically generate a list of industry-specific attributes. For example, in one implementation as illustrated in FIGS. 9A-9B, the verification and authentication of an individual providing services to seniors can be represented by various attributes: “county criminal,” “social security,” “national search,” “professional license,” “NIPR search”, “FINRA search”, “FAQS level 3,” “insurance,” and “code of ethics.”

The authentication program can present the results of the evaluation to the user in a number of different views. These views can include a company profile on a website, a chart view, which shows graphical charts and graphs representing the attributes and/or data of the service providers. Additionally, the authentication program can present a written report or text, a spreadsheet view of the attributes and/or data of the service providers. The reports can be generated such that they contain detailed information on projects and activities funded by a government program to promote transparency and provide the public with access to information on the manner in which funds are being expended down to the local level. These reports can be configured to provide the public with a level of transparency into how funding dollars are being spent to help drive accountability for the timely, prudent, and effective spending of funding dollars. The reports can include information to answer important questions, such as: (a) Who is receiving funding dollars and in what amounts? (b) What projects or activities are being funded by a specific government program? and (c) What is the completion status of such projects or activities and what impact have they had on job creation and retention? In various embodiments, the system can also provide a data feed to transfer the search results and report data to a third party.

In some embodiments, the system may include a knowledge-based database of the attributes that define how to interpret responses provided on the application in order to prompt the system to request additional information regarding the service provider, if needed. Namely, based upon the application information and the query results, the system can automatically deduce whether additional verifiable information should be elicited from the service provider. For instance, a service provider may indicate that she has a professional license, but her application does not provide the license details. As a result, the system can prompt the user to provider the missing information regarding the service provider. Thus, the system can be configured to automatically detect inadvertently or intentionally omitted information from the service provider's application or detect unexplained gaps in the service provider's information.

In cases where the system is requested to verify a business or organization as a service provider, the system can also be configured to determine which specific employees' qualifications should be authenticated and verified beyond the traditional background check. For example, a pop up box or another indicator may define that based on the time the business has been in operation, the CEO/owner must be verified.

Some embodiments of the present invention can provide a rating and comparative ranking tool. In addition to rating the service provider individually, in various embodiments, the present invention can be configured to rank the service provider in comparison to other service providers. This comparative ranking feature of the present invention in general can enable the comparison of one service provider relative to other similar service providers. The authentication program can be configured to monitor and compare the service providers on an ongoing basis. Additionally, the system and method can also provide regular due diligence investigations to ensure a service provider's compliance and to continuously verify the accuracy of the service provider's information.

Systems consistent with the present invention can provide an authentication program for verifying the identity of a service provider. After the service provider has been verified, the authentication program can provide the authenticated service provider with a registration number, certificate or other indicia indicating the successful completion of the evaluation process. The system can be configured to provide a variety of incentives for encouraging service providers to become an authenticated service provider. Once verified, the service provider can market itself through advertisements and promotional offerings as an authenticated entity that provides reputable goods and services.

After the completion of the verification process, whether successfully verified as an authenticated service provider or not, the system can be configured to retain the applicant's records and flies. Authenticated service providers can be permitted to establish a password to access the system to update their information, as needed. Similarly, using an established password, unsuccessful service providers can also access the system to update their records and files in order to resubmit their application. In addition to providing the authenticated service providers the option to voluntarily update their information, the system and method of the present invention can be configured to routinely monitor and update the background of its authenticated service providers in order to provide its user with the reassurance and confidence in the listed authenticated service providers.

Various embodiments of the present invention can provide a safe, trustworthy, and reliable means for a consumer or business to search for authenticated service providers. One or more databases of the system can be configured to maintain a list of authenticated service providers and a list of service providers whose applications were unsuccessful or a list of revoked service providers. The system can include one or more databases that enable the user to conduct a search based upon commonly known search strategies, such as by industry, registration number, a service provider's name, address, city or state, key word or topics search.

In general, the present invention provides a device and service to address and provide information that a consumer or business needs “to know” when selecting a service provider. Whether the user is a senior citizen who needs to know that a handyman or locksmith can be trusted . . . ; or a government agency that seeks transparency on every level of its vendor/contractor network . . . ; or a business or nonprofit that requires visibility for stockholders or board members . . . the present invention can authenticate and verify entities down to the individual employee level to mitigate risk and prevent fraud and abuse. To provide these benefits and services, various embodiments of the present invention relates to an authentication, fraud prevention, compliance monitoring, and job reporting method, apparatus, and systems for all types of service providers. Examples of such embodiments will be further explained below.

Operation of the various components of the system can be coordinated by the authentication platform, which can be configured to function as the main platform to coordinate access to various function platforms, such as a SeniorChecked (which is a trademark) platform, a job counting platform and a fraud prevention technology (FPT) platform. Access to these various platforms can be provided based on separate websites, username access levels, passwords or according to a menu-based system wherein a user is presented with the various options available and can select which functions to initiate.

Example of the Authentication and Verification System

Various embodiments of the present invention describe an authentication and verification system to assist customers and businesses in choosing a service provider. It should be understood that the authentication and verification system and method directed towards elder care providers as shown and described with references to FIGS. 1-9 are exemplary only. Those skilled in the art would understand that any and all types of services may be envisioned for the service provider without departing from the scope of the present teachings. Any and all service types can be offered according to the present invention. For example, service providers may provide for profit or non-profit services such as nursing, elder care, child care, doctors, lawyers, accountants, auto mechanics, government contractors, volunteers, board of director members, and the like.

Various embodiments of the present invention provides a computer based platform configured to offer authentication and verification services for providers who serve senior citizens. The authentication and verification services are commercially referred to as SeniorChecked. In various embodiments, the authentication and verification system and method provides a platform for elevating standards that better serve and safe-guard senior citizens by performing due diligence checks on both the providers (business entities) and the individuals (employees or volunteers) that come in contact with the senior population. Specifically, the authentication and verification platform will allow consumers an opportunity to verify that a provider of services has in fact been authenticated. Providers will have the ability to be authenticated as compliant against a pre-designated set of standards and code of ethics and thus, allowing them to market themselves as members of a network of authenticated providers. This status will allow them to identify and market themselves locally and/or nationally as an authenticated provider and provide them with access to additional services and programs offered by the present invention to help grow their business. These additional services and programs are described in further details below.

The present invention relates generally to an authentication and verification system that may be implemented via a web-based application platform that executes program code to generate the user-interfaces, perform business logic, process data, and store supporting data. The user interface may be viewed via standard web browser and the data may be stored in a SQL relational database or other suitable mechanism. Supporting documents, if needed, may be received into the platform through a web based file upload mechanism or, via an electronic fax (e.g., e-fax) component that converts and stores the faxes as electronic documents.

### Standards Verification:

In one embodiment, the process starts with a rigorous set of criteria that has been developed from analyzing companies experienced in background research. That process includes evaluating the “organization” which may be a company, professional, association, nonprofit agency or healthcare entity that works with seniors. In some embodiments, the process may be configured such that each type of organization must meet criteria in certain categories that may include licensing, insurance, and criminal/lawsuits. In various embodiments, the entities must provide an input to the sen or that indicates that they commit to a code of ethics and agree to have background checks performed on at least one employee.

The invention may further include providing individual background verification by searching, for example, a seven year residential history of an applicant after verification of the individual's social security number and full name has been confirmed. Up to three different counties may be searched based on any given applicant's mobility. For example, the county court records of each differing county address may be searched for any criminal felonies or misdemeanor offenses (as illustrated in FIGS. 9A-9B). Additionally, an applicant's identity may be searched against a group of national data bases containing nearly 200 million records from federal agencies such as the FBI, Dept. of Justice, U.S. Customs, U.S. Marshals, U.S. Secret Service, Drug Enforcement Agency, Office of Foreign Asset Control, Sex Offenders, Terrorist Watch List, etc. To date, the few employment laws or regulations that specify a background check must be performed are usually vague about the standards that should be reviewed. The background check of the present invention eliminates the inconsistency in the market and underscores the provider's commitment, trust and integrity to serving seniors. Thus, the present invention allows seniors and their family members to have assurance they are working with companies and individuals that have met the highest standards in the industry. The system may also be used to provide background verification of volunteers. While required by many state laws for child care, there is a need to authenticate volunteers entering the home of a senior citizen. These processes may be performed by the server in response to one or more commands from an operator using data stored (sufficient for performing the background check) of the applicant or volunteer in memory. Businesses may be similarly background checked. The results of each background check are stored in memory of the computer system.

### Validation:

Individuals (including volunteers) who have been verified as an authenticated service providers (i.e., have been background checked and undergone other processes described herein) will receive an identification card and identification number. Businesses may similarly receive an identification number. Seniors and their family members can then verify the authenticated servicer provider's identification number by phone or the Internet for any person desiring to enter their home. This ability to validate individuals (and businesses) will significantly increase the level of assurance for seniors and their family members about the individual and the company they represent. The database of all authenticated service providers will be available online or by calling a toll-free phone line. When accessed over the Internet, the system may be configured to allow consumers access, at no charge, to important information about each service provider including the internal quality control parameters and ratings as set forth by the operator including but not limited to, the frequency and consistency in which a company sends valid workers with proof of ID and ID (or certification) card—to a clients home. Further, the invention may be configured to allow consumers to submit firsthand ratings, and reviews for consideration by other consumers (e.g., via the Internet).

### Community for Seniors:

Various embodiments of the present invention provide a consumer-oriented marketing program for engaging and empowering seniors and their family members through a virtual senior action network. Seniors today are not the “retiring types” and remain very active in their communities, work and enjoyment of their lives. The virtual senior action network allows seniors and their family members to participate in creating their own local network of vetted service providers as well as serving as the quality assurance team for existing providers. The program can include an online newsletter, extensive health and wellness content and tools for being an advocate for healthy and successful aging.

An integral feature of the invention is the creation of a network of authenticated providers and individuals that can be accessed and utilized by consumers to fulfill needs. FIG. 1 is a diagram of the authentication and verification system according to an embodiment of a service provider and individuals (employee) process of the present invention. In FIG. 1, the process for the service providers begins with an application which allows for authentication and approval which will be communicated to the service provider to allow them to market their approved status to consumers.

FIG. 2 provides a diagram of the authentication and verification system according to an embodiment of the consumer process of the present invention. Using the exemplary system illustrated in FIG. 2, consumers will be able to search for designated service providers that have obtained proper status and will be offered an option to order or request services. The service providers and individuals can be verified by consumers that they are in fact authenticated and current. Based on their interest, consumers may have an option to post reviews of their experience with the service provider and decide whether they will choose to re-use the service in the future or, recommend the service provider to other consumers. This connectivity between the two constituencies based upon the authentication status forms the basis of the network.

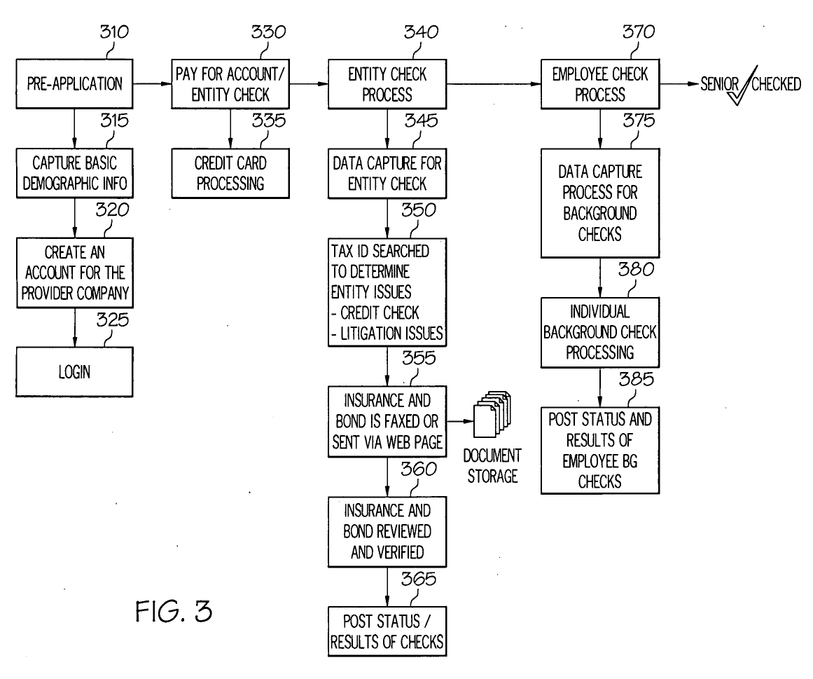

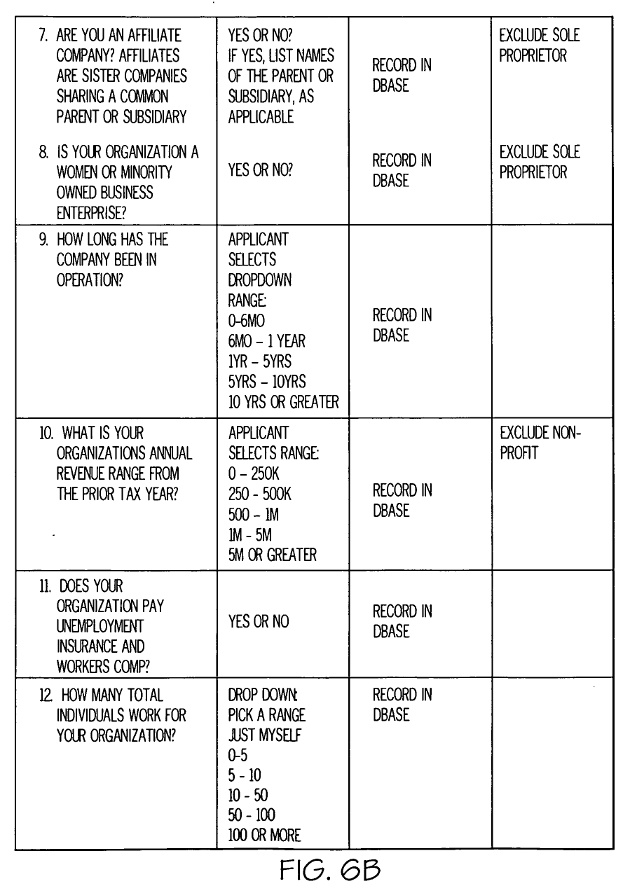

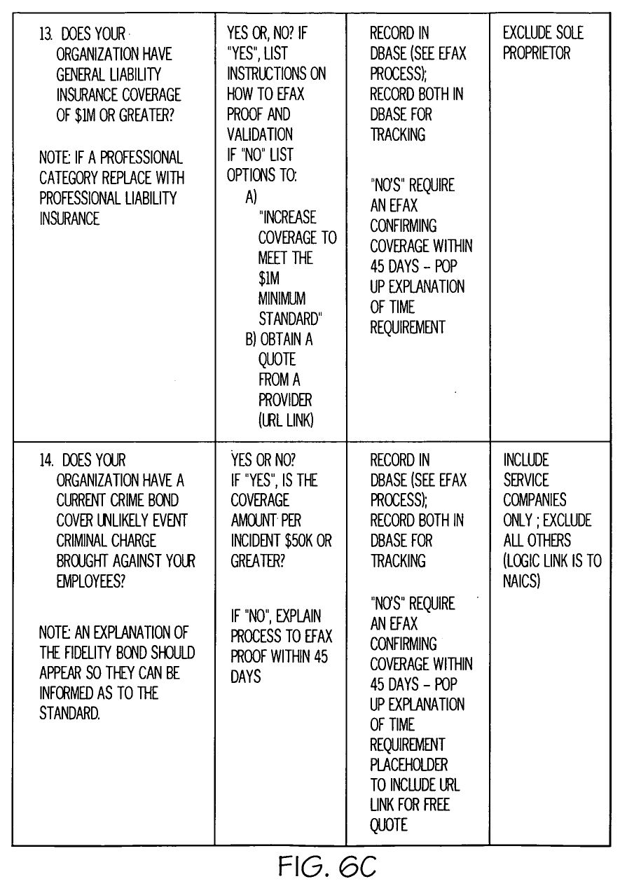

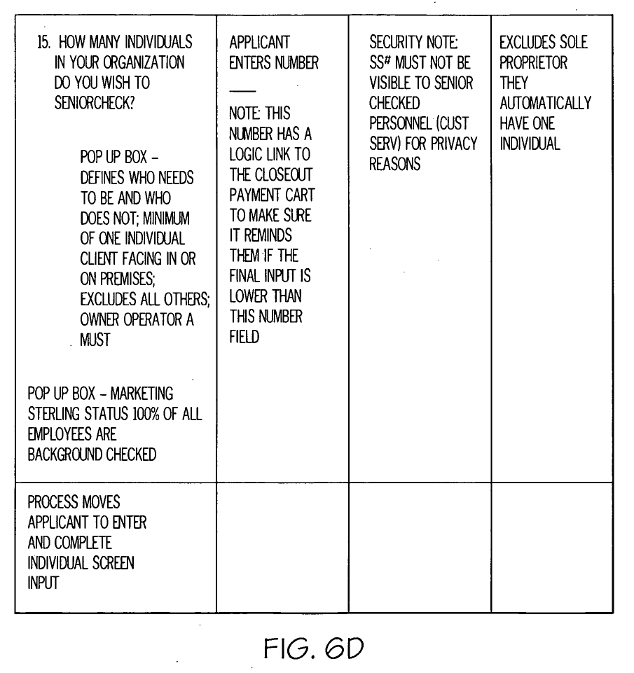

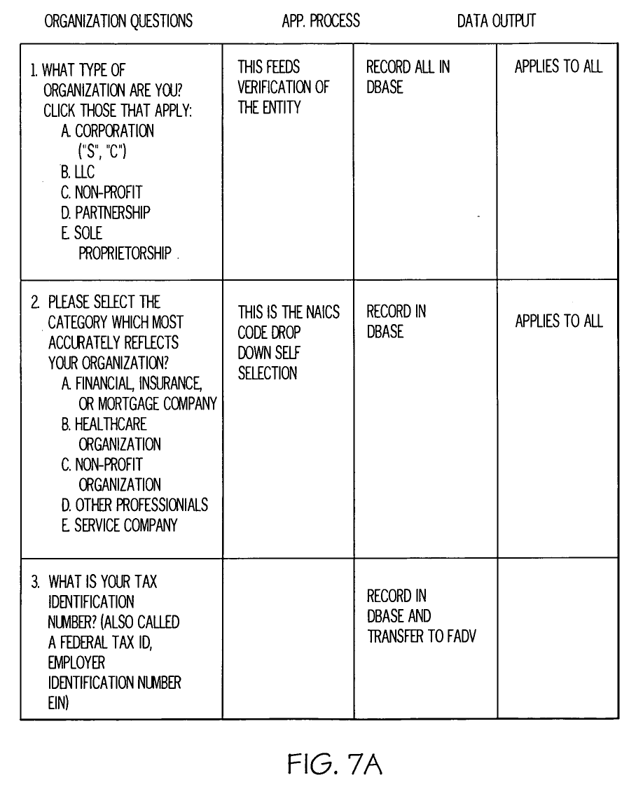

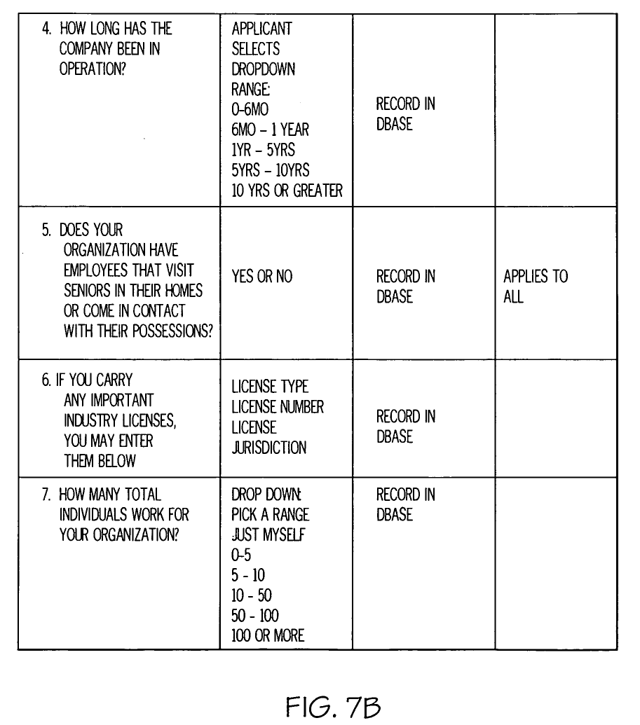

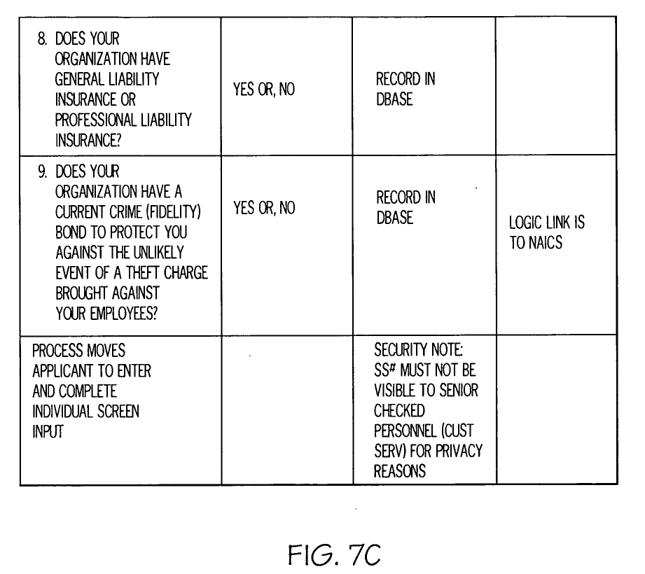

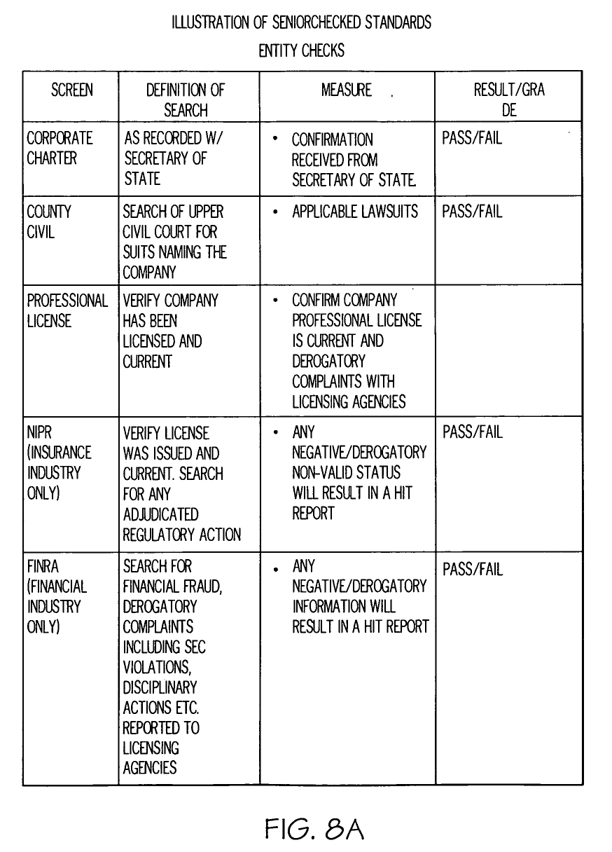

FIG. 3 shows an example workflow process for allowing a business and individuals to be verified as an authenticated service provider. In general in FIG. 3, the pre-application process is designed to gather specific demographic information regarding an applicant, namely, company name, contact name, mailing address, phone number and email. The information will be used to create a User Account login for the provider allowing for access to their proprietary and secure account information. The entity will input specific information essential to the entity background check including a federal tax ID number, company name, and company profile information as described in the exemplary questionnaire illustrated, in FIGS. 6A-6D and FIGS. 7A-7C. Additionally, the invention allows for the input, archive and retrieval of proof of insurance, bonding and confirmation of professional licensure depending on the specific industry. The process includes a payment facilitation component whereby the cost of the application can be paid by credit card and/or direct invoice depending on the company's needs. The final output will generate a “PASS/FAIL” result (Step 365) as to whether an entity has achieved all of the standards as verified in the authentication process. On a parallel path, the company can enter in the specific individual employee data, namely, full name, current address, date of birth and social security number.

Referring to FIG. 3, in step 310, the method begins the pre-application process. In step 315, the method captures basic demographic information and creates an account for the provider company in step 320 to create a login account in step 325. The method enables a user to pay for an entity to be checked and verified in step 330. Credit card processing may be used by the method in step 335 to pay for the check and verification request. In step 340, the method begins the entity check process by capturing data for the entity to be checked in step 345. The method may capture information such as the entity's tax identification, credit check status, and litigation issues in step 350. Additional information that may be received to be checked by the method in step 355 is insurance and bond information. The method may review and verify the insurance and bond information in step 360. The method can post the results of the check in step 365.

In step 370, an employee of the entity can be checked using the method. In step 375, the method captures data regarding the employee in order to conduct a background check. The method performs the background check in step 380 and posts the results of the employee background check in step 385,

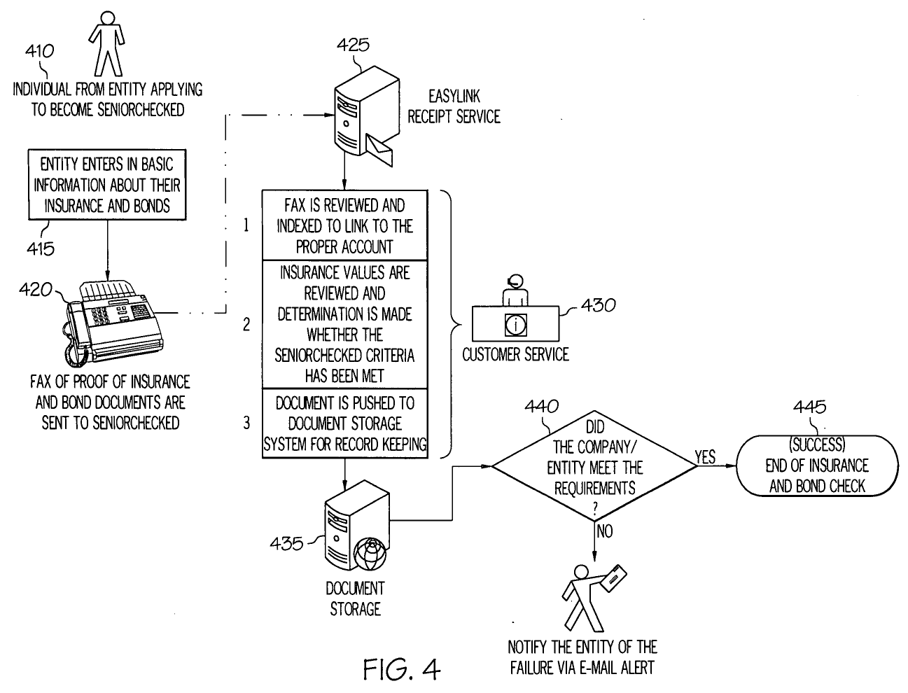

FIG. 4 illustrates an example workflow process for capturing and processing insurance and bond documents from service provider applicants. In FIG. 4, an individual from the entity applying to be verified is identified in step 410. In step 415, information about the entity's Insurance and bond information is entered into the system. The information can be transmitted into the system via facsimile in steps 420-425. Customer service may be provided either by electronic or human intervention in step 430 to assist with the receipt and storage of the information. The insurance and bond information can be stored in a computer database in step 435. In step 440, a check is performed to determine whether the company or entity met the requirements. If yes in step 440, a successful result is issued in step 445. If no in step 440, a FAIL notice may be issued.

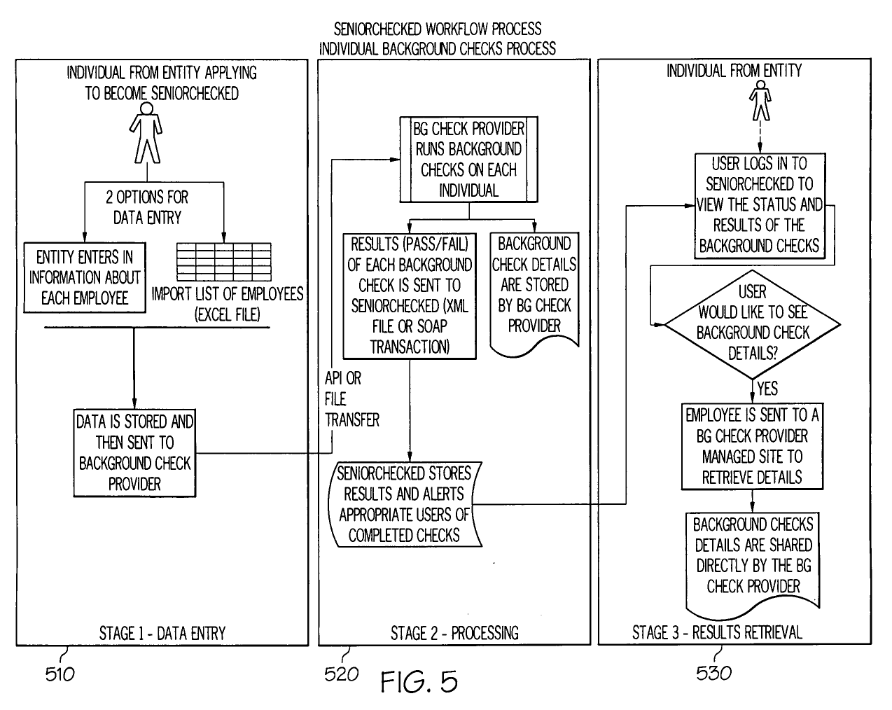

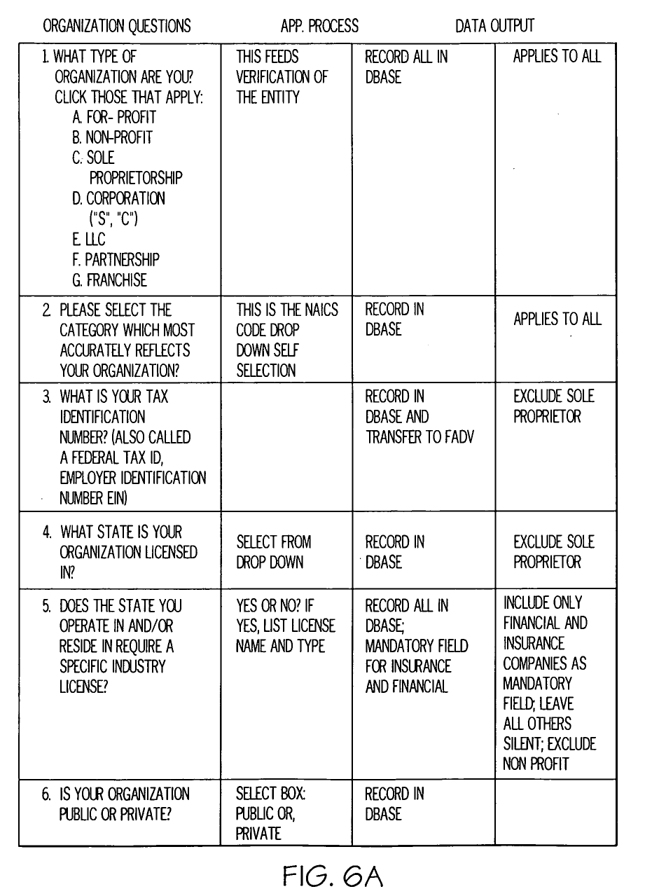

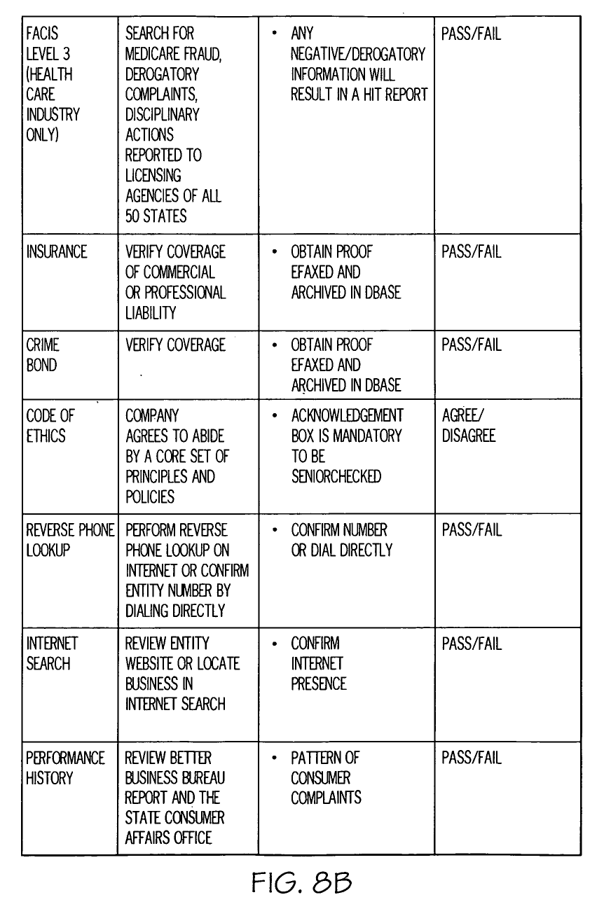

FIG. 5 shows an example workflow process for allowing an individual to be verified as an authenticated service provider. The individual authentication and verification shown in the exemplary embodiment in FIG. 5 can be conducted according to a three stage process including a data entry stage 510, a processing stage 520, and a results retrieval stage 530. FIGS. 6A-6D represent a table showing an example of the authentication data that can be gathered by the program regarding an organization during the application process. FIGS. 7A-7C represent a table showing another example of the authentication data that can be gathered by the program regarding an organization during the application process. FIGS. 8A-8B provide a table listing example standards that can be used for performing a business background check and for certifying the business. Similarly, FIGS. 9A-9B provide a table listing example standards that can be used for performing a background check on an individual and for certifying the individual.

As discussed, the background checks may be automated via the computer system, winch retrieves information from other remote databases, compares the retrieved information with a standard (stored in memory), and determines a result (e.g., pass/fail or requires operator review).

### Additional Products and Services:

As mentioned above, for certain applications, the authentication and verification platform offers incremental opportunities for providers and consumers to leverage the value of the network, in the following areas.

### Training:

In various embodiments, the authentication and verification platform can offer authenticated providers, individuals and volunteers Internet-based training to become better prepared to serve seniors. The training services can be implemented according to an Internet-based training curriculum for the senior services workforce and volunteers. Each training module can be purchased for a small fee by the individual or volunteer or the organization can purchase the modules in bulk with the requirements that each member pass the training prior to being authenticated.

### Advertising and Marketing:

In some embodiments, the system and method may be configured to offer to providers via a website the opportunity to determine their level of participation in marketing to seniors and their family members. As other free Internet sites have demonstrated, consumers are receptive to online advertising and marketing promotions. Service providers can develop an enhanced website about their company which will be hosted by the authentication and verification system. Unlike other Internet sites, service providers will not have to pay if a consumer “clicks-through” to their websites. In various embodiments, the system and method may be configured to charge a higher fee to the service providers for two measurable and response-driven programs:
A “click-to-call” program that connects the consumer with the service provider via a telephone call:
A service lead program allowing consumers to place orders directly with the service providers via the Web,

### Concierge Services:

The programs and services of the present invention can be backed by a comprehensive, 24/7 support center, which can be utilized to provide easy-to-access concierge services to seniors and their families. The concierge services can include complimentary access to information and support services. A fee may be charged to the service providers for any service coordination and other “hands on” advocacy. In various embodiments, the concierge services can be provided as an automated computer service, which is supported by human interaction. In other embodiments, the concierge services can be handled solely by a human operator. In both automated and human-interactive embodiments, the concierge services can assess customers' requests and identify the service provider or specialized advocate that will best meet their individual needs. Providing this link between seniors, their caregivers and qualified service providers is an important objective of the concierge services. The support center will also handle the inquiries and needs from both consumers and service providers.

### Additional Technology:

The present invention has been developed to support and market innovative technology including location-specific websites and kiosks for seniors who are not web-savvy. This invention assists with developing relationships with senior living communities, home owner/community associations, healthcare and professional organizations and pharmacy chains to bring authentication and verification service programs to their neighborhoods. The present invention combines a number of programs under “one roof” including media content, search directories, local and community events and health and wellness information. In various embodiments, an Internet-based Software as a Service (SaaS) technology model allows communities and associations to operate and manage their local information without the high costs of building their own independent systems. The software enables the efficient management of content and functionality to be provided on a client and location-specific basis.

Job Counting Platform

In various embodiments, the present invention provides a computer-based system and method, and a computer readable medium comprising software, for collecting and reporting specific data to include the automated tracking of the number of jobs created or retained as required by the American Recovery and Reinvestment Act of 2009. The job counting platform can be employed in a hosted, secure online environment to help users streamline the capture and report of Section 1512 data requirements.

As background information, the Recovery Act of 2009 provides significant funding to stimulate the economy and to create jobs. A principle of the Recovery Act is to ensure transparency, reporting and accountability. To prevent fraud and abuse, support the effective use of the funds and accurately measure and track results, recipients must publicly report on how funds are used. Due to its unprecedented scope, the Recovery Act funds are subject to additional and more rigorous reporting requirements than normally apply to recipients of agency funding, contracts, and awards.

Recipients of awards funded by the Recovery Act must comply with all reporting requirements outlined in Section 1512 of the Recovery Act. Recipients must also report on sub-recipient (sub-grantee and sub-contractor) activities as specified by the Recovery Act. Section 1512 of the Recovery Act (and subsequent guidance) subjects agencies and

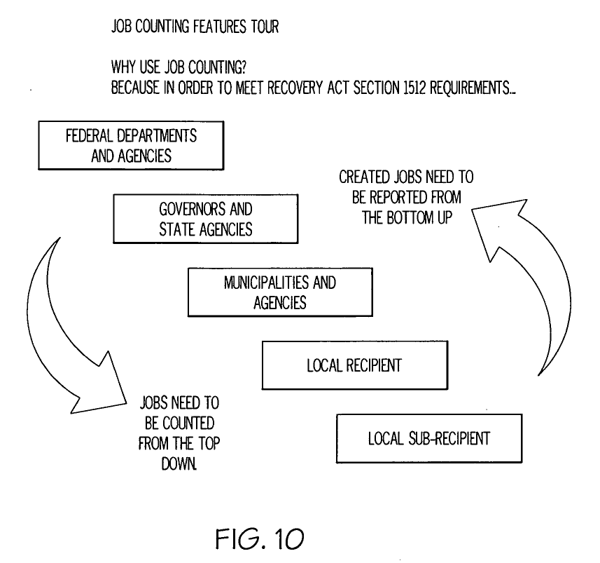

Using the job counting platform, efficient data collection can be achieved through standardized Web-based interfaces by pushing a data collection requirement from the top down through the hierarchy of recipients and sub-recipients (down through as many tiers as a recipient wishes), as shown in FIG, 10. Reporting and analytic functions can be provided for government agencies and recipients to monitor progress, activity and compliance in real-time. On a quarterly basis or according to any predefined time frame, information collection can be summarized for agencies to be compliant with the Recovery Act reporting requirements without relying on estimating and guesswork. The job counting platform can assure that real people in real jobs are being counted accurately from the bottom recipient level up, as depicted in FIG. 10, to prevent inaccurate “guesstimates” by recipients, or the use of “phantom” employees by fraudulent businesses.

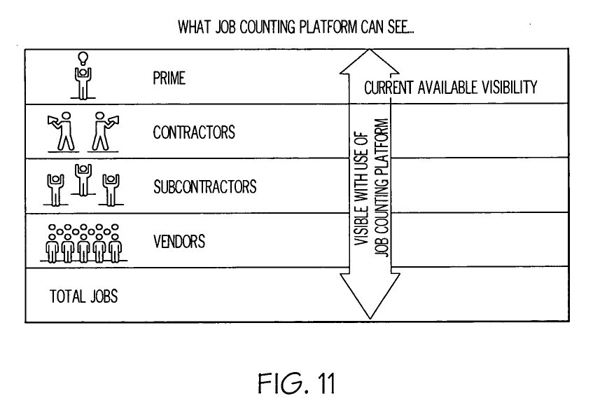

As a cost effective technology solution, the job counting platform can be easily integrated into a recipient's current IT architecture. The job counting platform can assist a recipient comply with the Recovery Act requirements easily and with minimal additional burden on the recipient's IT resources. The job counting online management portal can be configured to be “top down,” allowing the recipient to communicate job tracking requirements to its contractors and their multiple levels of sub-recipients. The job counting platform can be configured to ensure data integrity down through sub-recipient levels, as shown for example in FIG. 11.

Various embodiments of the job counting platform can provide an easy-to-use online registration. Once the recipient account setup is complete, the recipient can notify sub-recipients electronically to register and upload their job data through the secure server. The system can be configured to notify the recipient when the sub-recipients have completed that task so that reporting begins immediately on a real time basis.

Deployed as a web-based technology, in various embodiments, the job counting platform can enable recipients to know how many jobs are added or retained, within a time frame for a particular contract, in a particular location or through a particular contractor. The recipient can sort and view the data in a multitude of ways.

Using Software as a Service (SaaS) technology, the job counting platform can be easily integrated into the recipient's current IT system to help streamline accurate, auditable, compliance reporting, which is made available to the public at the website Recovery.gov. The SaaS technology can help to, for example, provide consistent data capture across all levels of recipients, report data on a real-time basis allowing any concerns to be internally managed, and support a submission of quarterly data to state agencies and/or Recovery.gov.

Various embodiments of the system can be configured such that the job counting platform is designed having the following exemplary technical specifications:
100% standards compliant Web-based Interface
Data import and export using Microsoft Excel files
XML Web service data interfaces available
Private data securely stored using AES 256-bit encryption; and
Only strong encryption of SSL connections are allowed (128 & 256 bit)

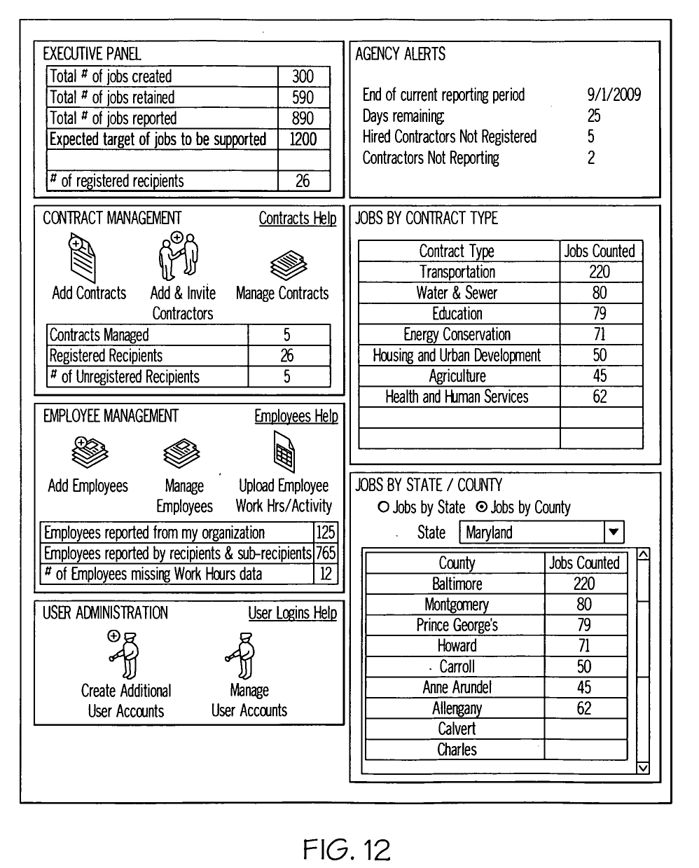

FIG. 12 illustrates an exemplary agency dashboard, which can serve as an account portal home access page for registered agencies. A similar dashboard can serve as a portal home access page for recipients. Access to the portal home page can be granted to the user after entry of a valid username and password. In FIG. 12, an agency can use the agency dashboard to perform several functions such as: add account users, manage contracts, oversee recipient compliance, view various reports, and monitor real-time job counts. As shown in FIG. 12, the exemplary agency dashboard can provide text, graphics and charts including detailed and cumulative information on the jobs created and retained. For example, the dashboard displays within the executive panel block the total number of jobs created, the total number of jobs retained, the total number of jobs reported, and the expected target of jobs to be supported. The dashboard may be configured to illustrate in a summarized-fashion the jobs created and retained based on the contract type. The dashboard also may display the number of jobs created and retained based upon a specific location, such as by state, county or geographic region.

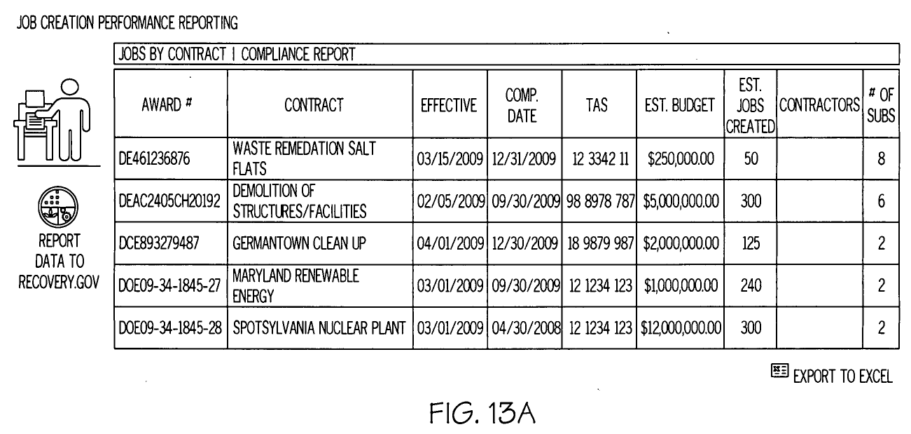

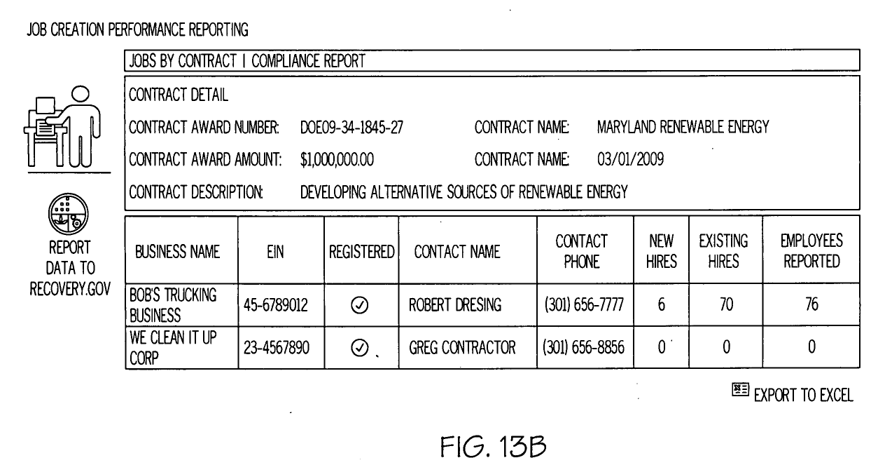

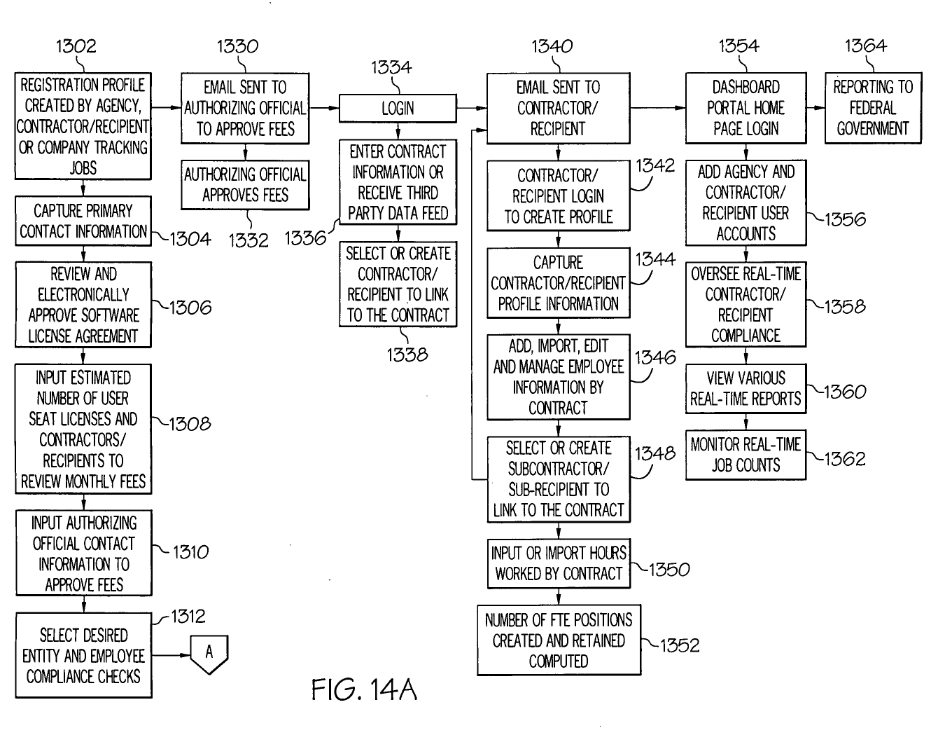

FIGS. 13A-13B illustrate exemplary detailed reports that can be generated by the job counting platform in real-time in accordance with the requirements of the Recovery Act. Real-time reports on all agency contracts can be made available to a registered agency or recipient through the dashboard, by selecting, for instance, the “Reports” tab or menu. From the dashboard page, shown in FIG. 12, the user can select the report tab or menu to view further detailed reporting. The job counting platform can be configured such that the reports can be viewed in many different ways. For example, one mandate of the Recovery Act requires separate job creation and retention reports for each funded award or contract. The detailed report can be generated by the job counting platform using the information stored within a job counting platform database. The reports are supported by the system and updated in real-time. Therefore, when recipients input their data into the job counting platform, the real-time reports are updated and made immediately available to the agency.

FIGS. 14A-14B illustrates an example workflow process for allowing an agency and/or recipient to register as a user to collect data and track the number of jobs created or retained as required by the Recovery Act of 2009. In FIGS. 14A-14B, the registration process is designed to gather specific information regarding an agency, contractor/recipient or a company tracking jobs to create an account login. Next, the user can be prompted to complete an agency, recipient or company profile. The final step in the registration process can be to prompt the user to create a checkout account. Once the users have created their job counting accounts, users can login to their dashboard to begin the process. Once logged into the system, additional authorized users can be added to the account. For example, the system can be configured, in some embodiments, to require that an agency list at a minimum two users—one of the users can be designated as the authorizing official to ensure accountability within the agency. Multiple users can be added to the account and each user can be set to have customized security access levels. For example, one user's account can be established so that the user only has access to view the reports, while another user can be established to have access to all aspects of the system. The system can be configured such that only a user's name and e-mail address are needed to create a new user account. Specific security levels can be established after the user account is created.

Another step in the job counting process can enable the user to add contracts by entering information such as: contract award number, contract name, effective date, place of performance, and the like. The contracts information can be stored in the job counting platform database. An agency and/or prime recipient can enter as many contracts Into the job counting platform as they wish to track.

The next step in the job counting process permits the user to select or create contractor/recipient information. For example, an agency user may be prompted by the system to enter information regarding the contractor or subcontractor awarded the contract. The recipient's information can be entered according to each recipient's respective contracts such that this information is also linked to the appropriate contract in the report section. By way of example, the agency can enter the recipient's name, a unique identification number such as the Federal Employer Identification Number or DUNS Number, and e-mail address as the recipient's information. This can trigger a detailed e-mail notification to be sent to the recipient explaining the job counting application and how they can enter their profile information online. The system provides an easy method for the recipient to create an account and input data. The agency can be notified when the recipient has completed entering the required information and satisfied the required reporting compliance. The same process can be followed for sub-recipients with no limitations.

Once the recipients create their account, the prime recipient and sub-recipients can add and manage new and retained employees designated under a specific contract, as well as input or import hours worked by employee on a regular basis. As the recipients and sub-recipients enter their information, it is captured in the job counting platform immediately so agencies and recipients can view the job count status and other reporting information in real time.

Referring to FIGS. 14A-14B, the method begins in step 1302 with a registration profile created by an agency, contractor/recipient or company tracking jobs. The method captures the primary contact information in step 1304. The method may prompt the user to review and electronically approve the software license agreement in step 1306. The method may then prompt in step 1308 the user to input the estimated number of user seat licenses and contractors/recipients in order to determine monthly fees. In step 1310, the method may request an input of the contact information for an authorizing official to approve the fees charged. In step 1312, the method allows the user to enter the desired entity and employee to be subjected to the compliance check. In FIG. 14B, the method begins the entity check process (step 1314), captures data for the entity check (step 1316), processes the entity check (step 1318), and posts the status/results of the checks (step 1320). Similarly, in step 1322, the method begins the employee check process, captures data for the background check of the employee (step 1324), performs the background on the employee (step 1326), and posts the status/results of the employee background checks (1328).

Returning to FIG. 14A, in step 1330, the method sends an email to the authorizing official for fee approval and the authorizing official approves the fees in step 1332. In step 1334, the method permits the user to login so that the user can enter information regarding the contract or receive a third party data feed. In step 1338, the method allows the user to select or create one or more contractors/recipients to be linked to the contract. In step 1340, the method automatically generates an email to be sent to the one or more contractors/recipients. The method allows each contractor/recipient to login and create a profile in step 1342. In step 1344, the method captures the contractor/recipient profile information. The method in step 1346 permits the user to add, import, edit and manage employee information by contract. In step 1348, the method enables the user to enter information to select or create subcontractors/sub-recipients to be linked to the contract. The method in step 1350 enables the user to input or import the hours worked by the contract into the system. In step 1352, the method automatically computes the number of full-time equivalent positions (FTE) created and retained. The formula for reporting the FTE jobs can be represented as:

$$\frac{Cumulative Recovery Act Funded Hours Worked ( Qtr 1 … n )}{Cumulative Hours in a Full \text{-} time Schedule ( Qtr 1 … n )} = F T E$$

In step 1354, a dashboard portal home page login is provided and displayed by the method on a display device of the system. By accessing the dashboard portal home page, the method enables the user to add agency and contractor/recipient user account information in step 1356. The method provides in step 1358 the user with the ability to oversee contract compliance in real-time. The method enables the generation of various real-time reports in step 1360. Step 1362 of the method enables the user to monitor job counts on a real-time basis. In step 1364, the information and data stored and collected in the system and displayed on the dashboard can be reported to, for example, the federal government.

Examples of data elements that can be collected and stored in the job counting platform regarding recipients, sub-recipients, and vendors under the terms of the Recovery Act are further described in Table 1 and Table 2 below:

TABLE 1

| RECIPIENT DATA ELEMENTS | DEFINITION |
|---|---|
| Funding Agency Name | Name of Federal Agency Managing the |
| | Funds. Awarding Federal agency and |
| | Organizational Element to Which Report |
| | is Submitted. |
| Funding TAS | Agency Treasury Account Symbol (TAS) - |
| | Program Source |
| AwardId | Federal Grant or Other Identifying |
| | Number Assigned by the awarding Federal |
| | agency. For grants: agency assigned award |
| | number For contracts: FPDS Data element |
| | 1A (Procurement Instrument Identifier or |
| | PIID, Order#). |
| RecipientDUNSNumber | Unique Identifier of Entity (DUNS No.) |
| | The prime recipient organization's 9 digit |
| | Data Universal Numbering System |
| | (DUNS) number or Central Contractor |
| | Registration plus 4 extended DUNS |
| | number. |
| RecipientMPINNumber | The MPIN is a mandatory data element |
| | created by the CCR registrant and must |
| | have nine characters: at least one letter |
| | (upper or lower case) and one number. No |
| | spaces or special characters are permitted. |
| ParentDUNSNumber | Unique Identifier of Parent Organization/ |
| | Company (DUNS No.) |
| RecipientEIN | The recipient organization's Employer |
| | Identification Number (EIN) provided by |
| | the Internal Revenue Service. |
| CFDANumber | Catalog of Federal Domestic Assistance: |
| | GSA, OMB; published description of |
| | Federal assistance program. Catalog of |
| | Federal Domestic Assistance (CFDA) |
| | number on the award document or |
| | provided by the awarding agency. If this |
| | award is being funded through multiple |
| | programs, provide each CFDA number. |
| RecipientName | Recipient Name and Address of |
| RecipientAddress1 | Organization. The legal name of recipient |
| RecipientAddress2 | organization and address, including zip |
| RecipientAddress3 | code. This should be the same name and |
| RecipientCity | address that appears in recipient's Central |
| RecipientState | Contractor Registration profile. |
| RecipientZipCode | |
| RecipientAccountNumber | Recipient's internal account number for |
| | project/award. The account number or any |
| | other identifying number assigned by the |
| | recipient to the award. This number is |
| | strictly for the recipient's use only and is |
| | not required by the awarding Federal |
| | agency. |
| ProjectGrantPeriod | Project/Grant Period (Period of |
| | performance) Indicates the project/grant |
| | period established in the award document |
| | during which Federal sponsorship begins |
| | and ends. Note: Some agencies award |
| | multi-year grants for a project/grant period |
| | (e.g., 5 years) that are funded in |
| | increments known as budget periods or |
| | funding periods. These are typically |
| | annual increments. Please provide the total |
| | project/grant period, not the individual |
| | budget period or funding period. |
| ReportPeriodEndDate | Reporting Period End Date. The frequency |
| | of required reporting is quarterly. Provide |
| | the ending date of the reporting period. |
| | For quarterly reports, the following |
| | calendar quarter reporting period end dates |
| | shall be used: 6/30; 9/30; 12/31; or 3/31. |
| | For final reports, the reporting period end |
| | date shall be the end date of the |
| | project/grant period. |
| FinalReport | Final Project Report Indicator (i.e. no |
| | future reports) (Y or N) Check “yes” only |
| | if this is the final report for the project/ |
| | grant period specified |
| ReportTypeFrequency | Report or Frequency. Select “quarterly” |
| | for quarterly reports. |
| AwardType | Transaction Type-Grant, Contract or |
| | Loan |
| AwardDate | Award Date (Date Signed) |
| AwardDescription | Award Title Description w/ purpose of |
| | each funding action. A brief descriptive |
| | title of the project or activity funded in |
| | whole or in part with Recovery Act funds. |
| | If this award funds multiple projects or |
| | activities, provide a descriptive title that |
| | captures the general focus area, e.g., |
| | “community development,” |
| | “comprehensive community mental health |
| | services to adults with a serious mental |
| | illness,” etc. |
| AwardAmount | Total Amount of Recovery Funds |
| | Received from Federal Agency - Federal |
| | Dollar Amount (obligation) |
| ProjectName | Name of Project |
| Activity_Code | Description of Project or Activity (NAICS |
| | code(s) or NTEE-NPC code(s)). For |
| | awards primarily funding infrastructure |
| | projects or activities, as defined by the |
| | awarding agency, provide the North |
| | American Industry Classification System |
| | (NAICS) code(s) that describe the |
| | Recovery Act projects or activities under |
| | this award. A searchable code list is at |
| | http://www.census.gov/naics/. For all |
| | other awards, provide the National Center |
| | for Charitable Statistics “NTEE-NPC” |
| | code(s) that describe the Recovery Act |
| | projects or activities under this award. A |
| | searchable code list is at |
| | http://nccsdataweb.urban.org/PubApps/nteeSearch. |
| | php?gQry=all-core&codeType=NPC. |
| Activity_description | Description of Projection or Activity |
| ProjectionDescription | Description of Project or Activity (brief |
| | narrative). A description of the overall |
| | purpose and expected outputs and |
| | outcomes or results of the award and first- |
| | tier subaward(s), including significant |
| | deliverables and, if appropriate, units of |
| | measure. For an award that funds multiple |
| | projects or activities, such as a formula |
| | block grant, the purpose and outcomes or |
| | results may be stated in broad terms. |
| ProjectStatus | Evaluation of completion status of the |
| | project or activity. The status of the work |
| | that has been completed. This evaluation |
| | should be based on performance progress |
| | reports and other relevant non-financial |
| | performance information. For awards |
| | funding a single project or activity, please |
| | choose one of the following options: Not |
| | started; Less than 50% completed; |
| | Completed 50% or more; Fully |
| | Completed. For awards funding multiple |
| | projects or activities, such as formula |
| | block grants, provide your best estimate of |
| | completion of all projects and/or activities |
| | based on any aggregate data and |
| | information. |
| JobCreation | Provide a narrative description of the |
| | employment impact of the Recovery Act |
| | funded work. This narrative should be |
| | cumulative for each calendar quarter and |
| | at a minimum, address the impact on the |
| | recipient's workforce, and if known, the |
| | impact on the workforces of sub |
| | recipients. At a minimum, the recipient |
| | shall provide-- (i) A brief description of |
| | the types of jobs created and jobs retained |
| | in the United States and outlying areas, |
| | and (ii) An estimate of the number of jobs |
| | created and jobs retained in the United |
| | States and outlying areas. At a minimum, |
| | this estimate shall include any new |
| | positions created and any existing filled |
| | positions that were retained to support or |
| | carry out Recovery Act projects or |
| | activities managed directly by the |
| | recipient, and if known, by sub recipients. |
| | The number shall be expressed as “full- |
| | time equivalent” (FTE), calculated |
| | cumulatively as all hours worked divided |
| | by the total number of hours in a full-time |
| | schedule, as defined by the recipient. |
| | (iii) A job cannot be reported as both |
| | created and retained. |
| NumberOfJobs | (ii) An estimate of the number of jobs |
| | created and jobs retained in the United |
| | States and outlying areas. At a minimum, |
| | this estimate shall include any new |
| | positions created and any existing filled |
| | positions that were retained to support or |
| | carry out Recovery Act projects or |
| | activities managed directly by the |
| | recipient, and if known, by subrecipients. |
| | The number shall be expressed as “full- |
| | time equivalent” (FTE), calculated |
| | cumulatively as all hours worked divided |
| | by the total number of hours in a full-time |
| | schedule, as defined by the recipient. For |
| | instance, two fill-time employees and one |
| | part-time employee working half days |
| | would be reported as 2.5 FTE in each |
| | calendar quarter. |
| FedExpenditure | Amount of recovery funds received that |
| | were expended to projects or activities |
| | (“Federal Share of Expenditures”). The |
| | cumulative total for the amount of Federal |
| | fund expenditures. For reports prepared on |
| | a cash basis, expenditures are the sum of |
| | cash disbursements for direct charges for |
| | property and services; the amount of |
| | indirect expense charged; the value of |
| | third-party in-kind contributions applied; |
| | and the amount of cash advance payments |
| | and payments made to subcontractors and |
| | subawardees. For reports prepared on an |
| | accrual basis, expenditures are the sum of |
| | cash disbursements for direct charges for |
| | property and services; the amount of |
| | indirect expense incurred; the value of in- |
| | kind contributions applied; and the net |
| | increase or decrease in the amounts owed |
| | by the recipient for (1) goods and other |
| | property received; (2) services performed |
| | by employees, contractors, subcontractors, |
| | subawardees, and other payees; and (3) |
| | programs for which no current services or |
| | performance are required. Do not include |
| | program income expended. |
| TotalInfrastructureExpenditure | Total cost of infrastructure investment |
| | made by State and Local governments. |
| | Provide the cumulative total cost of |
| | investment. This amount should include |
| | the total cumulative federal expenditures |
| | and non-federal expenditures for the |
| | infrastructure investment: Federal |
| | (Recovery Act funds): $. |
| | Federal (non-Recovery Act funds): $. |
| | NonFederal: $. |
| TotalFedARRAExpenditure | Total federal ARRA expenditure |
| TotalFedNonARRAExpenditure | Total federal non-ARRA expenditure |
| TotalNonFedExpenditure | Total non-federal expenditure |
| InfraStructureRationale | Rationale of the Award Recipient for |
| | funding the infrastructure investment with |
| | funds made available under the Recovery |
| | Act. Explain how the infrastructure |
| | investment will contribute to one or more |
| | purposes of the Recovery Act: Purposes: |
| | (1) To preserve and create jobs and |
| | promote economic recovery. (2) To assist |
| | those most impacted by the recession. (3) |
| | To provide investments needed to increase |
| | economic efficiency by spurring |
| | technological advances in science and |
| | health. (4) To invest in transportation, |
| | environmental protection, and other |
| | infrastructure that will provide long-term |
| | economic benefits. (5) To stabilize State |
| | and local government budgets, in order to |
| | minimize and avoid reductions in essential |
| | services and counterproductive state and |
| | local tax increases. |
| StateLocalContactName | Name, phone number, address and email |
| StateLocalStreetAddress1 | address of the appropriate contact in the |
| StateLocalStreetAddress2 | state/local government. |
| StateLocalStreetAddress3 | |
| StateLocalContactCity | |
| StateLocalContactState | |
| StateLocalContactZipcode | |
| StateLocalContactCountyCode | |
| StateLocalContactCongressionalDistrict | |
| (Optional) | |
| StateLocalContactEmail | |
| PopStateCode | Recipient Primary Place of Performance |
| PopLocationCode | (city, state, congressional district, and |
| PopCountyCode | country) physical location of primary |
| Pop Location Name | place of performance. |
| PopCongressDist | |
| RecipientAreaOfBenefit | The area of benefit may be: State, County, |
| | City, School District |
| SubContractAmountDisbursed | Amount of Subcontract or Subaward |
| | Disbursed. the cumulative amount of cash |
| | disbursed to the subawardee or |
| | subcontractor as of the reporting period |
| | end date |
| SubContractValue | Total Amount of Subcontract or Subaward |
| | (Ultimate Contract/Award Value). the |
| | anticipated total amount of cash to be |
| | disbursed to the subawardee or |
| | subcontractor by the expiration date of the |
| | subaward or subcontract, respectively. |
| SubawardDate | Subaward Date. the date the subcontract or |
| | subaward was signed (mm/dd/yyyy). |
| SubawardProjectGrantPeriod | Subaward Project/Grant Period. the |
| | project/grant period established in the |
| | subaward document during which |
| | sponsorship begins and ends. For multi- |
| | year awards for a project/grant period |
| | (e.g., 5 years) that are funded in |
| | increments known as budget periods or |
| | funding periods, please provide the total |
| | project/grant period, not the individual |
| | budget period or funding period. |
| SubRecipientPopStateCode | Subrecipient Place of Performance (city, |
| SubRecipientPopLocationCode | state, congressional district, and country). |
| SubRecipientPopCountyCode | physical loction of primary pace of |
| SubRecipientPopLocationName | performance. |
| SubRecipientPopStateCongressDist | |
| SubRecipientAreaofBenefit | The area of benefit may be: State, County, |
| | City, School District |
| SubRecipientOfficerName(5) | For the five most highly compensated |
| | officers of the entity: names. the names |
| | and total compensation of the five most |
| | highly compensated officers of the |
| | subrecipient entity according to the terms |
| | of the Recovery Act. |
| SubRecipientOfficerTotalCompensation | For the five most highly compensated |
| (5) | officers of the entity: total compensation |

TABLE 2

| VENDOR DATA | |
|---|---|
| ELEMENTS | DEFINITION |
| Awardld | Federal Grant or Other Identifying |
| | Number Assigned by the awarding Federal |
| | agency. For grants: agency assigned award |
| | number For contracts: FPDS Data element |
| | 1A (Procurement Instrument Identifier or |
| | PIID). |
| SubContractNumber | Award Number or Other Identifying |
| | Number Assigned by the Recipient Entity |
| VendorDUNS_Number | Subrecipient DUNS Number. the |
| | subrecipient organization's 9 digit Data |
| | Universal Numbering System (DUNS) |
| | number or Central Contractor Registration |
| | plus 4 extended DUNS number. |
| VendorHQZipcode | The zipcode of the subrecipient's |
| | headquarters. |
| VendorName | The name of the vendor |
| ProdSrvcDescription | A description of the product or service |
| | provided by the vendor |
| PaymentAmt | The amount paid to the vendor. |

In various embodiments, the system and method in accordance with the present invention can be used In conjunction with various regulatory programs so as to track and monitor compliance of the applicable rules, laws, and regulations. For example, in some embodiments, the system and method can be employed in use with monitoring compliance with the Green Jobs Act of 2007. In the Green Jobs Act of 2007, Congress authorized federal funding to provide research and training in renewable energy. The Green Jobs Act is a federal program to identify needed skills, develop training programs, and train workers for jobs in a range of green industries.

Another example is that the system and method can be configured to be employed to determine whether the requirements of the Davis Bacon Act of 1931 (DBA) applies to a contract and to determine compliance with the requirements of the DBA. The most important requirement of the DBA is that contractors and subcontractors must pay mechanics and laborers employed directly on the work site no less than minimum prevailing wages being paid to corresponding classes of laborers and mechanics employed on similar projects in the political subdivision (city, town, village, county, etc.) where the work is performed. The DBA does not apply to all types of contracts and does not apply to all types of employees, even if the DBA is applicable to the contract. The system and method can be designed to determine whether the requirements of the DBA applies to a contract, and, if so, to identify which classification of employees and which employees' wages should be tracked and monitored for compliance. For a contracting agency, the system and method can be used by contracting officers in complying with and reporting the determination of the proper classification of workers—that is, determining if the employee's wage classification fits with the employee's actual work performed, reviewing payrolls for compliance, and conducting investigations to determine compliance with labor standards provisions. The system and method can also be employed by government contractors to ensure compliance, because failure by the contractor to pay the required wages can result in several sanctions, including termination of the contract for default, an assessment of excess re-procurement costs, and debarment of the contractor from contracting with the government for a specified time.

A further example is the application of the system and method of the present invention to assist employers with I-9 Form and E-Verify compliance. Form I-9, Employment Eligibility Verification program, Federal law requires an employer to complete an I-9 Form for each newly hired employee to demonstrate the employer's compliance with the law and the employee's work authorization. To comply with the I-9 Form requirements, the employer must examine the employment eligibility and identify document(s) an employee presents to determine whether the document(s) reasonably appear to be genuine and relate to the employee and record the document information on the Form I-9. Allowing an employee to start work without completing an I-9 Form can subject an employer to legal penalties, such as civil fines and even criminal prosecution, for hiring an unauthorized worker. To verify an employee's work authorization, an employee can use the E-Verify system. It is noted that E-Verify is a registered trademark of the Department of Homeland Security (DHS). The E-Verify system, which is a free website operated jointly by several federal agencies, allows employers to electronically verify the employment eligibility of their newly hired employees. Effective Sep. 8, 2009, Executive Order 12989, as amended, directs federal agencies to require that all federal contractors agree to electronically verify the employment eligibility of their employees. The Department of Homeland Security (DHS) recently designated the E-Verify as the electronic employment eligibility verification system that all federal contractors must use for demonstrating their I-9 Form compliance. The system and method of the present invention can be used alone or in conjunction with the federal E-Verify system to verify compliance with the I-9 Form requirements. In various embodiments, the system and method can be used to collect, store, and report data required for compliance with the I-9 Form requirements. In some embodiments, the system and method can also be configured to capture and store electronic images of the I-9 acceptable documents presented by employees.

The system and method can also be used to support municipal programs, such as tax abatement programs. Local governments offer tax abatements as an incentive to companies to expand the local economy and to promote economic development by encouraging businesses to locate, expand and retain facilities in a community. A local government may formulate a commercial tax abatement program by deciding on a duration of a tax abatement and the percentage of the allowable tax break to offer to companies. The local government may offer a tax break for this temporary period to companies, for example, who develop designated lands or open a business to stimulate investment in specific areas of a community and promote local job growth. During this timeframe, companies forego paying taxes or pay reduced taxes as stipulated according to the tax abatement rules and regulations. Typically, tax abatements offer the benefits to the residents and the local government of creating and retaining local jobs. The system and method of the present invention can be used to collect, record and store data of the created and retained jobs and any other required data in order to document compliance with the tax abatement rules and regulations. Using the features described above, the present invention can be employed to substantiate the jobs created and retained in order to justify providing local and non-local companies with tax deductions, abatements, write-offs, and other benefits.

In various embodiments, the system and method can be configured to track and monitor all aspects of a specific regulatory program. On the other hand, in some embodiments, the system and method can be configured wherein it is customized and tailored to track and monitor compliance with specific identified rules and regulations of a regulatory program. In various embodiments, the system and method can be configured to track and monitor multiple regulatory programs, such as all the regulatory programs discussed above. For example, a federal or state agency can use the system and method to monitor and track compliance with one or more programs administered by the agency. Another example is that a business that operates in several different regulated industries that are governed by one or more regulatory agencies may employ the system and method to track, monitor, and report compliance with the rules and regulations required by each of the regulatory entities.

Various embodiments of the job counting platform can assist with data compliance, data quality review, analysis and improvement of data capture workflow, and provide administrative support (contract/grant data entry services, review and analyze system reports and draft and submit quarterly reports as required by Section 1512 of the Recovery Act.)

Fraud Prevention Technology (FPT) Platform

The present invention can also assist an entity to ensure the integrity of its organization by doing the legwork to authenticate partner or outsource businesses and organizations, subcontractors and vendors and the employees of all of the above. Various embodiments of the present invention can provide a FPT platform that reduces risk by offering front-end prevention from fraud and abuse. The fraud prevention technology can be licensed to an individual or company directly, licensed to a designated third party, or hosted on behalf of the user. The fraud prevention technology can be designed to offer a web-based interface that is simple, flexible and easy to access.

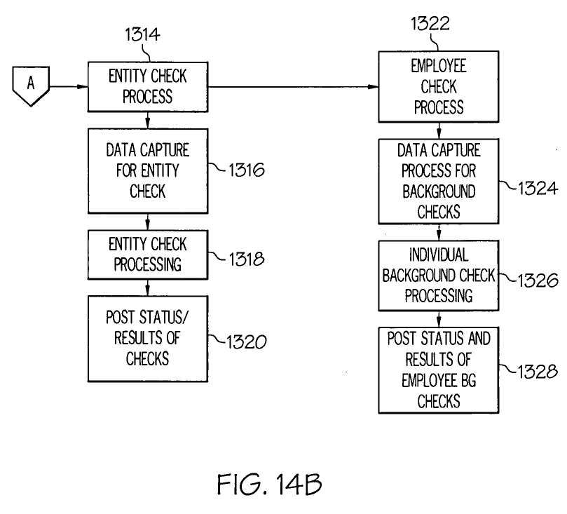

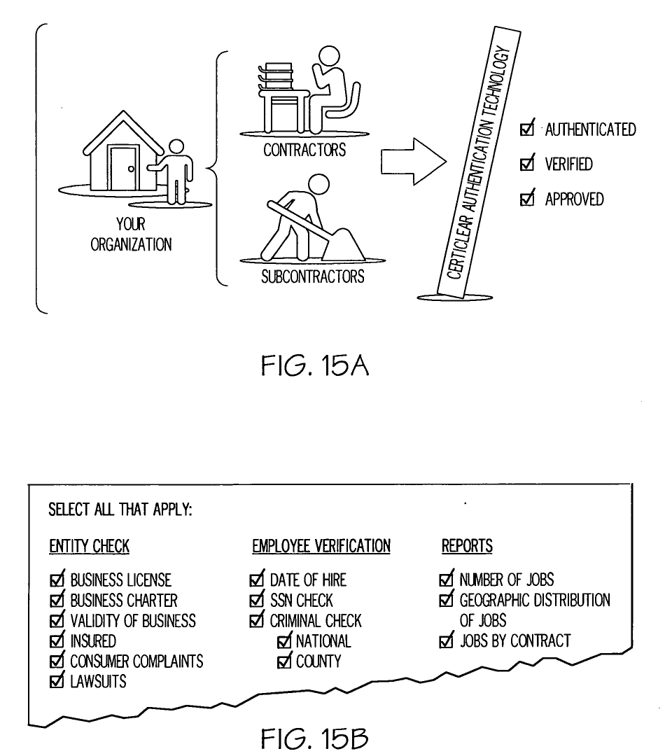

The FPT platform can also be customized and tailored to an individual's or organization's needs, as shown for example in FIG. 15A. The present system can assist in identifying the data points that each user needs to be verified, which can assist with setting consistent and stringent standards for the user's organization, while minimizing risk. Once those standards are set by the user, the FPT platform can evaluate the entities or individuals accordingly. A “Pass” or “Not Pass/FAIL” grade can be issued by fraud prevention technology based on the standards established by user.

Furthermore, the FPT platform can allow the user to request a display and a report of the information that a user believes is most relevant for his or her business and/or customer, as illustrated in FIG. 15B. Information collected can be reported back to the user through a comprehensive management portal or via a data feed of specific data fields customized to the user's needs and requirements. Upon entry to the portal, the fraud prevention technology “dashboard” can provide an overview of the data collected from entities and individuals in the user's program. Users can choose what they would like to have reported on their customized dashboard. Easy navigation tools can allow the user to drill down further into the data. The intuitive Web-based tool can permit the user to view information in individual profiles, manage and report on the user's program and the entities in it.

The FPT platform can be provided as a hosted solution to complement a user's or a company's existing IT Infrastructure to give the user accountability and visibility at every level. In one embodiment, the system can provide a web-based hosted solution through which application developers (or others such as IT personnel) create, manage and monitor application usage analytics in an online manner. In various embodiments, users can interact with the platform as a hosted service. In an alternative embodiment, the system may be implemented over a private network, or as a product (as opposed to a hosted or managed service).

The system can be configured for fraud prevention and data capture including the job counting and fraud prevention platform, wherein these hosted (SaaS) systems can be customized and installed behind firewalls. Additional provided IT services can include: software engineering and modifications, application development, system integration, information assurance and security management, data and/or system hosting and processing and IT help desk support services.

To minimize confusion regarding the new requirements of the Recovery Act or any other applicable rules and regulations used in conjunction with the present invention, the system can be designed to provide training and education services such as classroom and interactive training program,

An embodiment of the FPT process begins, initially, with an organization/entity submitting its application with all of the required documents (documents can be determined by standards that must be met). In the second step, the process can implement a verification process. Applications are subjected to the FPT platform's rigorous review process which may consist of verifying legitimacy, licensure, insurance/crime bond, identifying pending or past lawsuits, and consumer performance history. It is to be noted that all standards may be customized and the verifications developed for each in consultation with the client. In the third step, entities can be given a “Pass” or “Not Pass/FAIL” rating based on the pre-determined standards or requirements. In the fourth step of the process, the results of the verification process can be posted in an entity profile and rolled up under the overview results in the fraud prevention technology management portal “dashboard.” Alternatively, results can be communicated via a data feed to be imported into the user's database. The FPT platform of the system and method can be configured such that the user may have continuous access to management tools, including our FPT management portal, and customizable reports.

In some embodiments, the system can be configured to model the corporate structure of a business or an organization to determine which employees of the organization require further verification based upon the type of services being offered by the corporation. For example, a corporation may operate and provide numerous services within various industries to both government agencies and private businesses. During the authentication process of such a corporation, the system can be configured to model the corporate structure and determine based on the type of services being offered by the corporation which employees should be further authenticated.

While preferred embodiments of the present Invention have been described above, it is to be understood that any and all equivalent realizations of the present invention are included within the scope and spirit thereof. Thus, the embodiments depicted are presented by way of example only and are not intended as limitations upon the present invention. While particular embodiments of the invention have been described and shown, it will be understood by those of ordinary skill in the art that the present invention is not limited thereto since many modifications can be made. Therefore, it is contemplated that any and all such embodiments are included in the present invention as they may fall within the literal or equivalent scope of the appended claims.

What is claimed is:

1. A method of using a computer, comprising:
receiving data of a plurality of businesses;
accessing data about the plurality of businesses in one or more remote computers;
for each business, determining whether the data satisfies a plurality of business criteria;
issuing a certification identification number for each business for which the data of the business satisfies the plurality of business criteria;
not issuing a certification identification number for each business for which the data of the business does not satisfy the plurality of business criteria;
receiving data of a plurality of individuals;
accessing data about the plurality of individuals in one or more remote computers;
for each individual, determining whether the data satisfies a plurality of individual criteria;
issuing a certification identification number for each individual for which the data of the individual satisfies the plurality of individual criteria;
not issuing a certification identification number for each individual or which the data of the individual does not satisfy the plurality of individual criteria;
storing in a database identifying information for each individual and business having issued a certification identification number; and
allowing consumers to access the database, via the Internet or by telephone, to verify that a person or company has been issued a certification identification.

2. The method of claim 1, further comprising defining the plurality of business criteria and individual criteria based upon a plurality of industry based groups.

3. The method of claim 1, wherein, for each business, determining whether the data satisfies the plurality of business criteria comprises assessing one or more of the following:
a) type of business entity;
b) tax identification;
c) state of incorporation;
d) state required industry license;
e) identification of corporate affiliations;
f) number of years of operation;
g) annual revenue;
h) unemployment insurance and worker's compensation payment status;
i) number of employees;
j) liability insurance;
k) crime bond status; and
l) identification of employees to verify.

4. The method of claim 1, wherein, for each business, identifying one or more employees for verification based upon one or more goods or services rendered by the business.

5. The method of claim 1, wherein one or more individuals selected from the plurality of individuals is an owner or an employee of one or more businesses selected from the plurality of businesses.

6. The method of claim 1, wherein, for each individual, determining whether the data satisfies the plurality of criteria comprises assessing one or more of the following:
a) business credit;
b) corporate charter;
c) pending or prior lawsuits;
d) professional license;
e) verification of insurance coverage;
f) crime bond status;
g) reverse phone lookup;
h) Internet search; and
i) consumer performance history.

7. The method of claim 1, wherein allowing the consumers to access the database further comprises verifying that the person or company has been issued the certification identification by searching the database based upon at least one consumer search criteria.

8. The method of claim 7, wherein, for each business, the at least one consumer search criteria is selected from one or more of the following:
a) type of business entity;
b) tax identification;
c) state of incorporation;
d) state required industry license;
e) corporate affiliations;
f) number of years of operation;
g) annual revenue;
h) unemployment insurance and worker's compensation payment status;
i) number of employees;
j) liability insurance status;
k) crime bond status;
l) the certification identification number;
m) type of goods or services rendered by the business;
n) location;
o) a number of employees having a pre-defined educational background;
p) a number of employees having a pre-defined technical expertise; and
q) a number of employees having a pre-defined number of years of experience.

9. The method of claim 7, wherein, for each individual, the at least one
consumer search criteria is selected from one or more of the following:
a) business credit rating;
b) corporate charter;
c) pending or prior lawsuits;
d) professional license;
e) insurance coverage status;
f) crime bond status;
g) consumer performance history;
h) the certification identification number;
i) types of goods and services rendered by the individual; and
j) location.

10. A method of using a computer, comprising:
receiving data of a plurality of businesses;
accessing data about the plurality of businesses in one or more remote computers;
selecting one or more pre-selected businesses from the plurality of businesses;
for each pre-selected business, defining a plurality of customized business criteria;
for each pre-selected business, determining whether the data satisfies the plurality of customized business criteria;
issuing a certification identification number for each pre-selected business for which the data of the business satisfies the plurality of customized business criteria;
not issuing a certification identification number for each pre-selected business for which the data of the pre-selected business does not satisfy the plurality of customized business criteria;
receiving data of a plurality of individuals;
accessing data about the plurality of individuals in one or more remote computers;
selecting one or more pre-selected individuals from the plurality of individuals;
for each pre-selected individual, defining a plurality of customized individual criteria;
for each pre-selected individual, determining whether the data satisfies the plurality of customized individual criteria;
issuing a certification identification number for each pre-selected individual for which the data of the pre-selected individual satisfies the plurality of customized individual criteria;
not issuing a certification identification number for each pre-selected individual or which the data of the pre-selected individual does not satisfy the plurality of customized individual criteria;
storing in a database identifying information for each pre-selected individual and pre-selected business having issued a certification identification number; and
allowing users to access the database, via the Internet or by telephone, to verify that a person or company has been issued a certification identification.

11. The method of claim 10, wherein the defining of the plurality of customized business criteria is based upon a plurality of industry based groups.

12. The method of claim 10, wherein, for each pre-selected business, determining whether the data satisfies the plurality of customized business criteria comprises assessing one or more of the following:
a) type of business entity;
b) tax identification;
c) state of incorporation;
d) state required industry license;
e) identification of corporate affiliations;
f) number of years of operation;
g) annual revenue;
h) unemployment insurance and worker's compensation payment status;
i) number of employees;
j) liability insurance;
k) crime bond status; and
l) identification of employees to verify.

13. The method of claim 10, wherein one or more of the pre-selected individuals is an owner or an employee of one or more of the pre-selected businesses.

14. The method of claim 13, further comprising, for each pre-selected business, identifying one or more employees for verification based upon one or more goods or services rendered by the pre-selected business.

15. The method of claim 10, wherein, for each pre-selected individual, determining whether the data satisfies the plurality of customized individual criteria comprises assessing one or more of the following:
a) business credit;
b) corporate charter;
c) pending or prior lawsuits;
d) professional license;
e) verification of insurance coverage;
f) crime bond status;
g) reverse phone lookup;
h) Internet search;
i) consumer performance history; and
j) compliance with Form I-9, Employment Eligibility Verification.

16. A method for collecting and reporting data for facilitating an American Recovery and Reinvestment Act of 2009 (Recovery Act) compliance process using a computer, the method comprising:
receiving data of a plurality of entities;
accessing data about the plurality of entities in one or more remote computers;
receiving data of a business relationship between each contractual related entity of the plurality of entities, wherein the contractual related entities are associated based upon a contract;
receiving contract data based upon the contract;
tracking data of a number of jobs created by the contractual related entities based upon the contract;
tracking data of a number of jobs retained by the contractual related entities based upon the contract;
storing in a database the data of the number of jobs created and the data of the number of jobs retained based upon the contract;
calculating data of a jobs created full-time equivalent based upon the data of the number of jobs created and calculating a jobs retained full-time equivalent based upon the number of jobs retained;
storing in the database the data of the jobs created full-time equivalent, the data of the jobs retained full-time equivalent, and the contract data;
determining whether the data of the jobs created full-time equivalent, the data of the jobs retained full-time equivalent, and the contract data satisfy requirements of the Recovery Act; and
periodically reporting, based on a pre-determined time period, the data of the jobs created full-time equivalent, the data of the jobs retained full-time equivalent, and the contract data to a government agency.

17. The method of claim 16, wherein the contract comprises a multi-level contract having recipients associated with different levels of contract performance;
wherein tracking the data of the number of jobs created comprises tracking at each level of the multi-level contract and tracking the data of the number of jobs retained comprises tracking at each level of the multi-level contract; and
wherein a sub-recipient performing the multi-level contract at a lower level electronically reports data in compliance with the requirements of the Recovery Act to a recipient performing the multi-level contract at a higher level so that data compliance reports are generated for each level of the multi-level contract.

18. A computer system for implementing an authentication, compliance monitoring, and job reporting program, the system comprising:
a processor; and
a memory, coupled to the processor, to receive and store data associated with an entity; wherein the memory further includes code that is executable by the processor and the code comprises:
an authentication and verification application for determining whether the data of the entity satisfies a plurality of criteria and issuing a certification identification number if the data of the entity satisfies the plurality of criteria;
a job counting application for tracking data of a number of jobs created by the entity based upon a contract, tracking data of a number of jobs retained by the entity based upon the contract, and determining whether the data of the number of jobs created, the data of the number of jobs retained, and contract data based upon the contract satisfy requirements of an American Recovery and Reinvestment Act of 2009 compliance program; and
a customized fraud prevention application for defining a plurality of customized criteria and determining whether the data of the entity satisfies the plurality of customized criteria.

19. A method of using a computer to detect fraud and abuse and to promote spending transparency, the method comprising:
receiving data of an entity;
accessing data about the entity in one or more remote computers to detect occurrences of fraud and abuse committed by the entity;
determining whether the data of the entity satisfies a plurality of criteria and issuing a certification identification number if the data of the entity satisfies the plurality of criteria;
determining whether the data of the entity is in compliance with at least one government regulation; and
defining a plurality of customized criteria and determining whether the data of the entity satisfies the plurality of customized criteria.

20. The method of claim 19, wherein determining whether the data of the entity is in compliance with the at least one government regulation comprises:
receiving contract data based upon a contract associated with the entity;
tracking data of a number of jobs created by the entity based upon the contract;
tracking data of a number of jobs retained by the entity based upon the contract;
storing in a database the data of the number of jobs created and the data of the number of jobs retained based upon the contract;
calculating data of a jobs created full-time equivalent based upon the data of the number of jobs created and calculating a jobs retained full-time equivalent based upon the number of jobs retained;
storing in the database the data of the jobs created full-time equivalent, the data of the jobs retained full-time equivalent, and contract data based upon the contract;
determining whether the data of the jobs created full-time equivalent, the data of the jobs retained full-time equivalent, and the contract data satisfy requirements of the at least one government regulation, wherein the at least one government regulation comprises rules and regulations of an American Recovery and Reinvestment Act of 2009 compliance program; and
reporting the data of the jobs created full-time equivalent, the data of the jobs retained full-time equivalent, and the contract data to a government agency

21. The method of claim 19, wherein the at least one government regulation comprises rules and regulations of at least one of a Green Jobs Act compliance program and a Davis Bacon Act compliance program.

22. The method of claim 19, wherein determining whether the data of the entity is in compliance with the at least one government regulation comprises:
receiving contract data based upon a contract associated with the entity;
determining whether the data about the entity and the contract data satisfy rules and regulations of a tax abatement program offered by a government entity to promote local economic growth;
storing in a database compliance data regarding whether the data about the entity and contract data satisfy the rules and regulations of the tax abatement program;
reporting the compliance data and contract data to the government entity; and
calculating at least one of a tax abatement, a tax deduction, and a tax write-off for the entity if the compliance data and the contract data satisfy the rules and regulations of the tax abatement program.
